(19) United States
(12) Patent Application Publication
(10) Pub. No.: US 2026/0261557 A1
(43) Pub. Date: Sep. 3, 2026

(54) PRIVATE SERVICE ACCESS (PSA) FOR ACCESSING CLOUD SERVICES

(71) Applicant: Oracle International Corporation, Redwood Shores, CA (US)

(72) Inventors: Gopinath Gopalakrishnan, San Ramon, CA (US); Martin John Sleeman, Redmond, WA (US); Thomas Ray Bakita, Saint George, UT (US); Leonard Thomas Tracy, Bothell, WA (US); Shuvabrata Ganguly, Seattle, WA (US); Girish Nagaraja, Sammamish, WA (US); Pradeep Vincent, Bothell, WA (US); Troy Ari Levin, Huntingdon Valley, PA (US)

(73) Assignee: Oracle International Corporation, Redwood Shores, CA (US)

(21) Appl. No.: 19/322,213

(22) Filed: Sep. 8, 2025

Related U.S. Application Data
(60) Provisional application No. 63/765,157, filed on Feb. 28, 2025.

(51) Int. Cl. H04L 9/40

(52) U.S. Cl. CPC H04L 63/10; H04L 63/0272

(57) ABSTRACT

Techniques for providing a private service access (PSA) object for accessing a cloud service from a virtual cloud network (VCN) using a private internet protocol (IP) address are provided. In an example method, a cloud computing environment associated with a cloud service provider (CSP) provides a PSA object for accessing a cloud service from a VCN, the PSA object being associated with a virtual network interface card (VNIC), the VNIC being associated with a private IP address, in which the IP address is from a range of private addresses associated with the VCN. The cloud computing environment receives, by the VNIC associated with the PSA object, a request to access the cloud service from a client connected to the VCN. The cloud computing environment routes the request to the cloud service using the VNIC and the PSA object.

### CROSS REFERENCE TO RELATED APPLICATION

This application claims priority to provisional application U.S. Ser. No. 63/765,157 entitled “Private Service Access (PSA) for Accessing Cloud Services” and filed on Feb. 28, 2025, the entire disclosure of which is incorporated herein by reference for any purpose.

### FIELD

The present disclosure relates generally to cloud computing and networking, and more particularly to techniques for providing a private service access (PSA) object for accessing a cloud service from a virtual cloud network (VCN).

### BACKGROUND

A cloud service provider (CSP) may offer customers the capability to configure and use a virtual cloud network (VCN), a kind of private virtual network. A VCN can provide services and capabilities such as establishing public or private subnets, defining IP address ranges for those subnets, routing tables to manage traffic routing in and out of the VCN, security lists or network security groups, and so on. Within a VCN, multiple subnets can be defined, each representing a segmented range of IP addresses used to isolate resources by security or function.

CSP customers can use the VCN by, for example, standing up a compute instance on the VCN and attaching a virtual network interface card (VNIC) to the new compute instance that is assigned to a subnet in the VCN. This enables the compute instance to communicate over the VCN with other network resources, both within the subnet and without. The compute instance can then be used to host applications, process data, run virtual machines, and so on, while its network communications are managed by components of the VCN.

One common configuration for a VCN involves establishing a private subnet with an associated range of private IP addresses. Compute instances on this private subnet can communicate with other compute instances within the same subnet or other subnets on the VCN, if allowed by the configured security rules. Private subnets are, however, limited by design in their ability to communicate with networks external to the VCN, such as the public internet or other VCNs unless explicit routing or gateway configurations are provisioned to enable such communication. These restrictions exist to ensure that data is not exposed outside of the security boundaries of the VCN, such as being routed over the public internet or being otherwise exposed to data exfiltration vulnerabilities.

Various solutions exist for enabling compute instances or other resources to access CSP-managed services from within VCNs. For example, some CSPs may offer a service gateway (SGW). An SGW can enable compute instances in a VCN to access specific CSP-managed services public IP addresses. The services include management application programming interface (“APIs”) for database services, object storage endpoints, telemetry services such as logging or monitoring, and so on. Traffic routed through the SGW remains on the CSP's internal network and does not traverse the public internet.

Another example of a service offered by some CSPs is a private endpoint (PE). A PE involves establishing a dedicated VNIC for a VCN to access a particular resource (e.g., a database instance or an object storage bucket) associated with a CSP service using a private IP address and dedicated API for that particular resource. The PE may be implemented as by configuring a VNIC within the VCN, enabling traffic to the resource to be routed entirely over the CSP's internal network, eliminating the need for internet traversal or public IP exposure.

### BRIEF SUMMARY

Techniques for providing a private service access (PSA) object for accessing a cloud service from a virtual cloud network (VCN) using a private IP address are disclosed. The PSA object can be used to offer fine-grained, per-service access controls, for specific cloud services using a private IP address to CSP customers.

In an example method, a cloud computing environment associated with a cloud service provider provides a first PSA object for accessing a first cloud service from a VCN, the first PSA object being associated with a first VNIC, the first VNIC being associated with a first private IP address, in which the first IP address is from a range of private addresses associated with the VCN. The cloud computing environment receives, by the first VNIC associated with the first PSA object, a first request to access the first cloud service from a client connected to the VCN. The cloud computing environment routes the first request to the first cloud service using the first VNIC and the first PSA object.

An example non-transitory computer-readable storage medium stores instructions that, when executed by one or more processors, can cause the one or more processors to perform operations including providing a first PSA object for accessing a first cloud service from a VCN, the first PSA object being associated with a first VNIC, the first VNIC being associated with a first private IP address, in which the first IP address is from a range of private addresses associated with the VCN. The operations can include receiving, by the first VNIC associated with the first PSA object, a first request to access the first cloud service from a client connected to the VCN. The operations can include routing the first request to the first cloud service using the first VNIC and the first PSA object.

An example system includes one or more processors and one or more computer-readable storage media storing instructions which, when executed by the one or more processors, can cause the one or more processors to perform operations including providing a first PSA object for accessing a first cloud service from a VCN, in which the first PSA object is associated with a first private IP address from a range of private addresses associated with the VCN. The operations can include receiving a first request to access the first cloud service from a client connected to the VCN. The operations can include routing the first request to the first cloud service using the first PSA object.

### BRIEF DESCRIPTION OF THE DRAWINGS

FIG. 1 depicts a cloud computing environment for providing a private service access (PSA) object for accessing a cloud service from a virtual cloud network (VCN), according to some aspects of the present disclosure.

FIG. 2 depicts PSA objects in a cloud computing environment for accessing a cloud service from a VCN, according to some aspects of the present disclosure.

FIG. 3 shows a flowchart of an example method for providing a PSA object for accessing a cloud service from a VCN, according to some aspects of the present disclosure.

FIG. 4 shows a flowchart of an example method for providing a PSA object for accessing a cloud service from a VCN, according to some aspects of the present disclosure.

FIG. 5 depicts a user interface (UI) for configuring a PSA object for accessing a cloud service from a VCN, according to some aspects of the present disclosure.

FIG. 6 shows a flowchart of an example method for using a PSA object for accessing a cloud service from a VCN, according to some aspects of the present disclosure.

FIG. 7 is a block diagram illustrating one pattern for implementing a cloud infrastructure as a service system, according to at least one embodiment.

FIG. 8 is a block diagram illustrating another pattern for implementing a cloud infrastructure as a service system, according to at least one embodiment.

FIG. 9 is a block diagram illustrating another pattern for implementing a cloud infrastructure as a service system, according to at least one embodiment.

FIG. 10 is a block diagram illustrating another pattern for implementing a cloud infrastructure as a service system, according to at least one embodiment.

FIG. 11 is a block diagram illustrating an example computer system, according to at least one embodiment.

FIG. 12 is a high level diagram of a distributed environment showing a virtual or overlay cloud network hosted by a cloud service provider infrastructure according to certain embodiments.

FIG. 13 depicts a simplified architectural diagram of the physical components in the physical network within CSPI according to certain embodiments.

FIG. 14 shows an example arrangement within CSPI where a host machine is connected to multiple network virtualization devices (NVDs) according to certain embodiments.

FIG. 15 depicts connectivity between a host machine and an NVD for providing I/O virtualization for supporting multitenancy according to certain embodiments.

FIG. 16 depicts a simplified block diagram of a physical network provided by a CSPI according to certain embodiments.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

Various examples described herein relate to services offered by a cloud services provider (CSP). In general, a CSP may provide one or more cloud services to subscribing customers using resources and infrastructure provided by the CSP. These resources may include compute resources (e.g., CPUs, GPUs, host machines), memory resources, networking resources, and other types of resources. A customer can subscribe to one or more cloud services provided by the CSP.

Infrastructure-as-a-Service (IaaS) is a type of cloud computing service where the CSP provides infrastructure that can be used by customers to build their own customizable networks and deploy customer resources, sometimes referred to as cloud service provider infrastructure (CSPI). The customer's resources and networks are thus hosted in a distributed environment by infrastructure provided by the CSP. This is different from traditional computing, where the customer's resources and networks are hosted by infrastructure provided by the customer.

The physical resources and infrastructure provided by the CSP may form a physical network, which is also referred to as a substrate network or an underlay network. Virtualization software may be executed by these physical resources to provide a virtualized distributed environment “on top” of the underlay network. The virtualization creates an overlay network (also known as a software-based network, a software-defined network, or a virtual network) over the physical network. A given physical network can support one or multiple overlay networks.

Customers can build their own virtual networks using compute, memory, and networking resources provided by the CSP. One or more customer resources or workloads, such as compute instances, can be deployed on these virtual networks. For example, a customer can use resources provided by the CSP to build one or multiple customizable private virtual network(s) referred to as virtual cloud networks (VCNs). A customer can deploy one or more customer resources, such as compute instances, on a customer VCN. Compute instances can take the form of virtual machines, bare metal instances, and the like.

As mentioned above, various solutions exist for enabling compute instances or other resources to access CSP-managed services from within VCNs. However, the existing solutions are not suitable for all use cases. For example, some CSP customers may require or desire the capability to access to only specific service application programming interface (APIs) using private IPs from a VCN. The existing solutions do not offer fine-grained, per-service access controls, requiring instead exposure to a number of service APIs, many of which may not be required for a particular application, thereby increasing the surface area for potential security or authorization issues. Furthermore, the existing solutions do not enable the use of private IP addresses from within in the VCN.

Techniques for providing a private service access (PSA) object for accessing a cloud service from a VCN such as a customer VCN are provided to address these challenges. The PSA is a new networking construct that provides per-service API access using a private IP from within the customer's VCN. In an example method, provided to illustrate certain concepts, a cloud computing environment associated with a CSP provides a PSA object for accessing a cloud service from a VCN. The PSA object may be associated with a VNIC that is associated with a private IP address from a range of private addresses associated with the VCN.

For example, the PSA object can be created by the cloud computing environment in response to a network administrator for a CSP customer selecting a particular service they need from a service catalog and providing configuration information such as the VCN, private IP address range, a domain name alias for accessing the service, and so on. The cloud computing environment can then generate the PSA object, including a dedicated VNIC managed by the CSP for the PSA object, to enable access to the cloud service from the VCN over the CSP's CSPI, without traversing the public internet or other public networks. The PSA object can be further configured, using the dedicated VNIC, to support features such as network traffic logging, virtual traffic mirroring, network path diagnostics, custom security attributes, and so on.

The cloud computing environment then receives from, for example, a compute instance associated with the VCN and by the VNIC associated with the PSA object, a request to access the cloud service from a client connected to the VCN. The client may be, for example, program code executing in a software application hosted by the compute instance. The cloud computing environment routes the request to the cloud service using the PSA object. The request is routed to the cloud service over physical and virtualized network components operated by the CSP. The PSA object can also route responses from the cloud service back to the compute instance.

Systems and methods according to the present disclosure provide significant improvements in the technical field of cloud computing and networking. The per-service API access mechanism via private IP addresses provided by the PSA object enables network configurations that were unattainable using existing approaches, enabling network exposure to only necessary service endpoints, reducing the attack surface for security threats and minimizing risks associated with over-broad network for compute instances in the VCN. The PSA construct also facilitates direct, private connectivity to cloud services without requiring public internet traversal, supporting compliance and security requirements for sensitive workloads. The flexibility to configure the PSA object with features such as traffic logging, mirroring, diagnostics, and custom security attributes enables network administrators to monitor, secure, and audit service access with fine-grained control, thus gaining the advantages of the PSA with no downside. The techniques disclosed herein also improve the functioning of computers themselves by providing a new link between VCNs and publicly available cloud services. Overall consumption of computing and networking resources is reduced through the elimination of unnecessary network hops and public internet exposure required by existing workarounds.

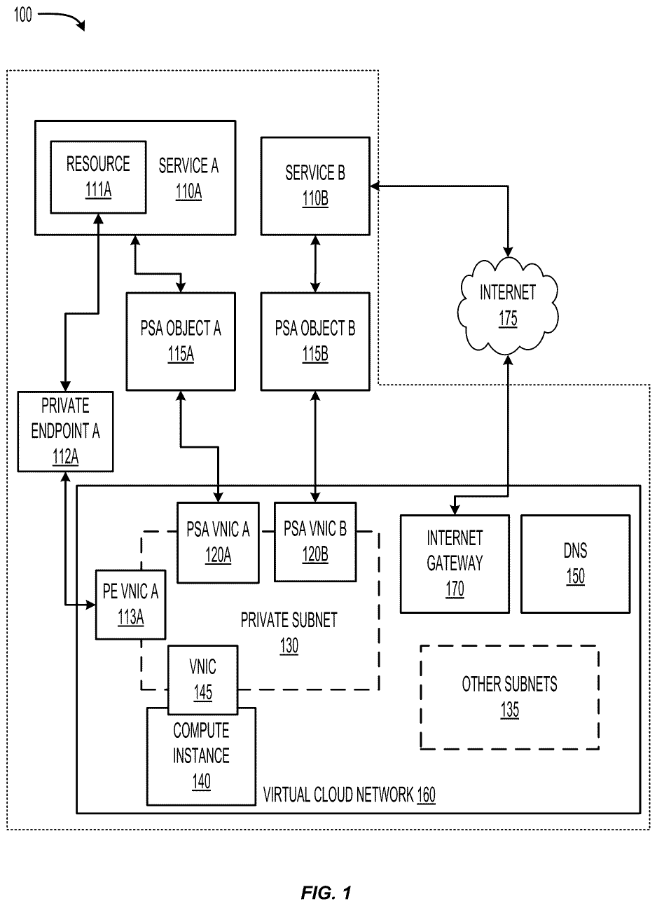

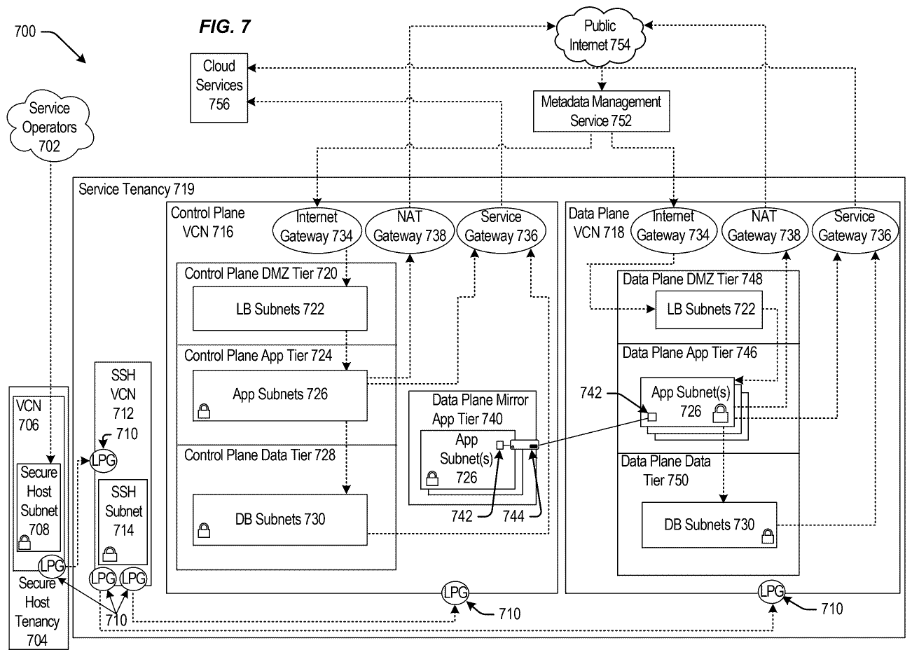

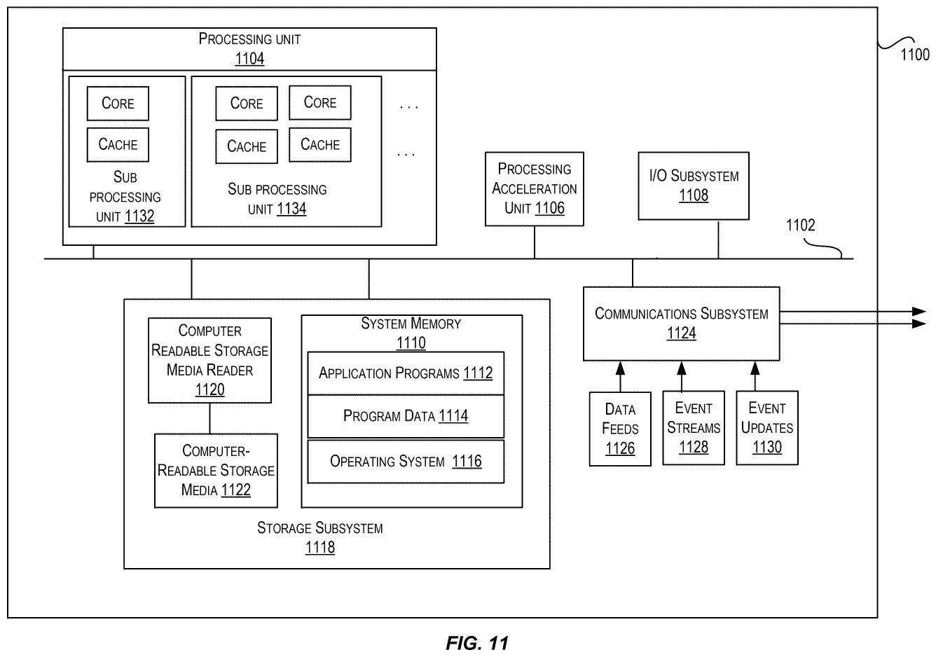

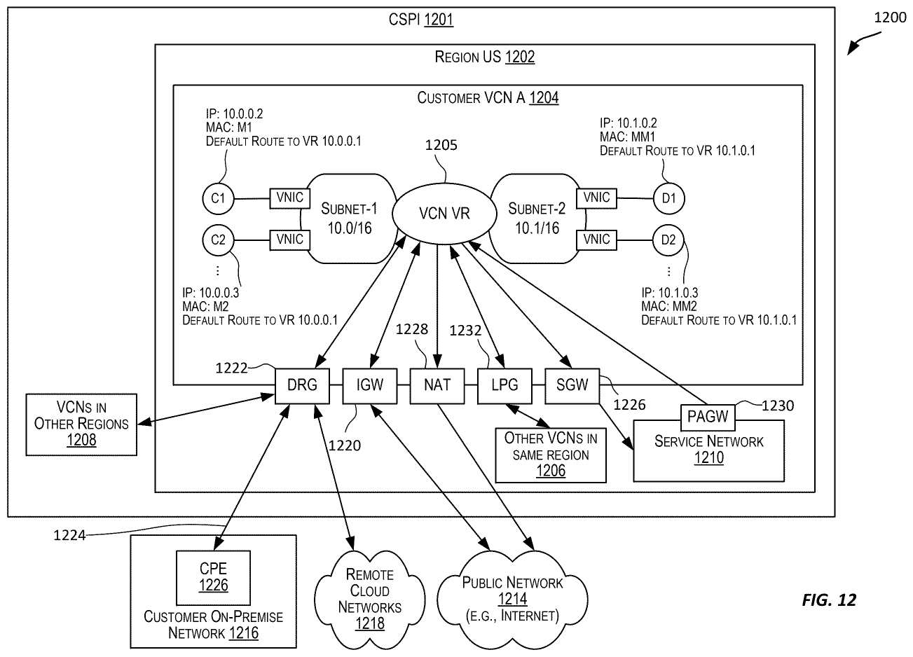

FIGS. 1-6 describe examples and embodiments related to providing a PSA object for accessing a cloud service from a VCN using a private IP address. FIGS. 7-10 depict examples of architectures for implementing cloud infrastructures for providing one or more cloud services, where the infrastructures may incorporate teachings described herein. FIG. 11 depicts a block diagram illustrating an example computer system or device, according to at least one embodiment. FIGS. 12-16 and the associated description provided in the “Example Virtual Networking Architecture” section below describe networking concepts including network virtualization, substrate networks, overlay networks, VNICs, etc., and provide examples of environments in which certain embodiments described in this disclosure may be implemented.

### PSAs in a Cloud Computing Environment

Referring first to FIG. 1, FIG. 1 depicts a cloud computing environment 100 for providing a PSA object for accessing a cloud service from a VCN, according to some aspects of the present disclosure. The cloud computing environment 100 includes CSPI 105 operated by a CSP. For example, the CSPI 105 may be a distributed underlay network of geographically separated data centers interconnected by high-speed links, used to provide services such as virtualized compute, storage, networking, identity management, and so on. External to the CSPI 105 is the public internet 175 that is reachable by various components included in the CSPI 105 through virtualized interfaces and other networking constructs.

The CSP provides a number of services 110A, 110B, such as control plane services for managing instances of cloud resources such as compute, networking, and storage. The services 110A, 110B can expose programmatic APIs for orchestrating the provisioning, configuration, and lifecycle management of resource instances within the CSPI 105. For example, service 110A may be the control plane for a database service offered by the CSP. A CSP customer can use the service 110A to instantiate a resource 111A, such as an instance of the database controlled using service 110A.

The cloud computing environment 100 includes a VCN 160 provisioned for a CSP customer. The VCN 160 may be, for example, a VCN. The VCN 160 can provide an isolated virtualized network within the CSPI 105. The VCN 160 can be used in to establish public or private subnetworks (“subnets”), route tables, gateways, and other networking constructs to enable communication among compute instances and with external networks.

The VCN 160 can include a number of subnets. FIG. 1 shows a private subnet 130 and other subnets 135. The private subnet 130 may be configured with a range of private IP addresses corresponding to resources and virtual devices that do not have direct access to or from the public internet or other external networks. In some cases, the private subnet 130 can be configured to route network traffic to external networks using virtualized technologies such as a network address translation (NAT) gateway or SGW.

The other subnets 135 may include, for example, a public subnet. The public subnet can include network resources with public IP addresses or access to an internet gateway 170, allowing inbound and outbound traffic over the public internet or other external networks. The internet gateway 170 may be a virtualized network component that provides a path for network traffic between resources in the public subnet and the public internet. The internet gateway 170 can support inbound traffic to public IP addresses in the public subnet and outbound traffic from compute instances to external endpoints. In general, the VCN 160 may include multiple private subnets and multiple public subnets.

The private subnet 130 and the other subnets 135 may each be defined as a logically isolated range of IP addresses within the VCN 160 and implemented in a software-defined networking layer provided by the CSP. Routing between and among endpoints in the private subnet 130 and the other subnets 135 can be governed by route tables (not shown) that define how traffic is directed within the VCN 160 and to external destinations via components such as NAT gateways, SGWs, internet gateways 170, as well as the private endpoint and PSA object described below.

The VCN 160 includes a domain name service component (DNS) 150 that can provide virtualized name resolution service to network resources in the private subnet 130 and the other subnets 135. The DNS 150 can be used for resolution of hostnames within the VCN 160 as well as for external DNS queries that can be resolved internally or forwarded to public DNS resolvers. The DNS 150 can be used, for example, to configure a DNS record that causes a hostname and a path used to access a cloud service (e.g., service 110A) to resolve to a private IP address in the private subnet 130.

Both the private subnet 130 and the other subnets 135 can include compute instances such as compute instance 140 connected to the VCN 160 via VNIC 145. A compute instance is a virtual computer provisioned and managed by the CSP, with allocated CPU, memory, and storage resources. CSP customers can use compute instances for running applications, hosting services, processing data, and so on. The VNIC 145 acts as a virtual networking device that attaches the compute instances 140 to private subnets 130. The VNICs 145 is assigned IP addresses and can send and receive traffic within the VCN 160. Each VNIC 145 is associated with one subnet and may be assigned both private IP addresses when situated in private subnet 130 or public IP addresses when situated in public subnets.

In some cases, the compute instance 140 on private subnet 130 may need to access services, resource instances, or other network locations within the CSPI 105 and operated by the CSP. In general, the compute instance 140 cannot access external network locations with IP addresses that are outside the range of private IP addresses associated with the private subnet 130. Resource instances, such as a database instance, can be communicated with using network constructs such as a private endpoint (PE). FIG. 1 depicts private endpoint 112A configured to provide access to resource 111A via VNIC 113A. However, as discussed above, the existing solutions for accessing the services 110A, 110B from the private subnet 130 such as service gateways (SGWs) are over-inclusive, offering a network gateway function for private networks that access to all service public APIs or control planes using public IP addresses. Such a configuration does not offer fine grain per-service access controls and opens the door to data-exfiltration as well as unauthorized use of certain services.

The systems and methods according to this disclosure can be used to provide a PSA object that can overcome the shortcomings of an SGW and enable access to a particular service 110A, 110B using a private IP address associated with a VNIC. VCN 160 shows two PSA objects, PSA object 115A and PSA object 115B. PSA object 115A is configured to enable access to service 110A via a private IP address associated with dedicated VNIC 120A. PSA object 115B is configured to enable access to service 110B via a different private IP address associated with dedicated VNIC 120B. The PSA objects 115A, 115B can provide private access to the respective services 110A, 110B from customer workloads such as compute instance 140 in private subnet 130 of VCN 160. In some examples, access to the services 110A, 110B can be provided from physical, “on-premise” computers or networks via the VCN (not shown). The PSA objects 115A, 115B and the associated VNICs 120A, 120B can be further configured to support features such as network traffic logging, virtual traffic mirroring, network path diagnostics, custom security attributes, and so on. Additionally, the PSA objects 115A, 115B and the associated VNICs 120A, 120B can be configured to enforce identity and security policies for fine grained access and data-exfiltration controls. FIG. 1 depicts an example with two PSA objects 115A, 115B and two respective services 110A, 110B. In general, multiple PSA objects may be created for a given service, including multiple PSA objects for one private subnet, for one or more different private subnets, for different VCNs, or combinations thereof.

In some examples, the PSA objects 115A, 115B can be created by provisioning routing to the respective services 110A, 110B within the CSPI 105, mapping the services 110A, 110B to the VNICs 120A, 120B. The CSP can configure routing and access policies to forward traffic to and from the private IP address of the VNICs 120A, 120B to the corresponding service. DNS 150 can be used to configure fully qualified domain names (FQDNs) to resolve to private IPs reachable within the private subnet 130. The CSP can enforce traffic constraints using internal software-defined network (SDN) policies, security groups, rules, and so on to ensure only authorized requests from within the VCN can access the respective service using the PSA objects 115A, 115B.

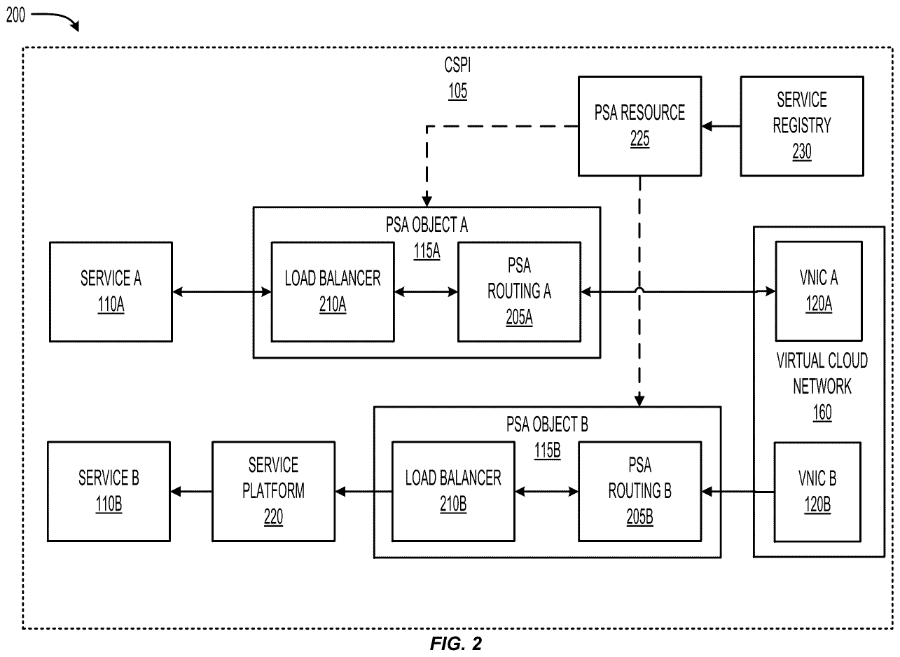

FIG. 2 depicts PSA objects in a cloud computing environment 200 for accessing a cloud service from a VCN, according to some aspects of the present disclosure. PSA objects 115A, 115B can be instantiated by a PSA resource 225, which serves as the control plane for PSA objects created and operating within the CSPI 105. The PSA resource 225 can be accessed using a suitable interface such as a web-based graphical user interface (“GUI”) or command-line interface (“CLI”).

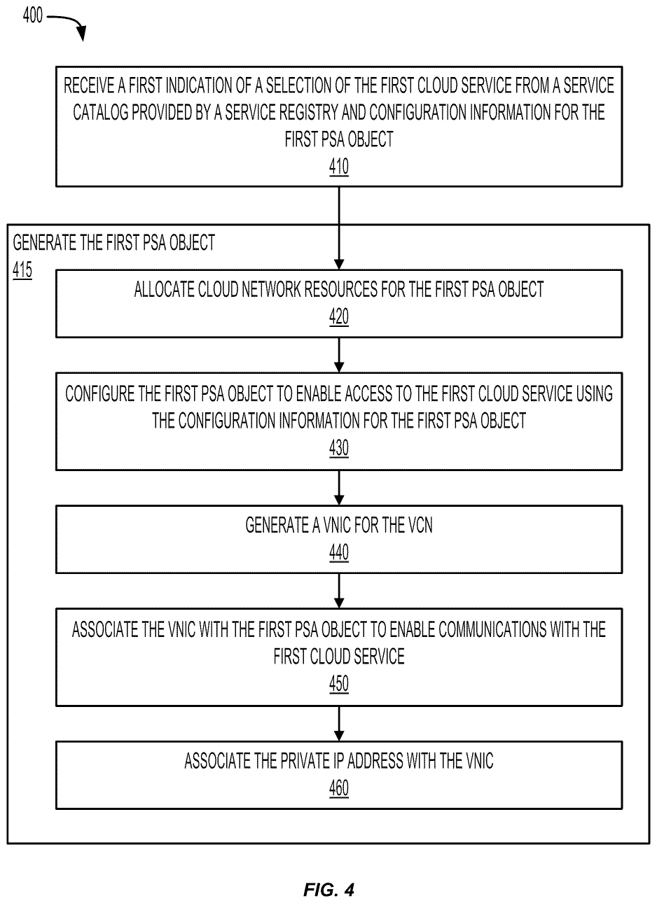

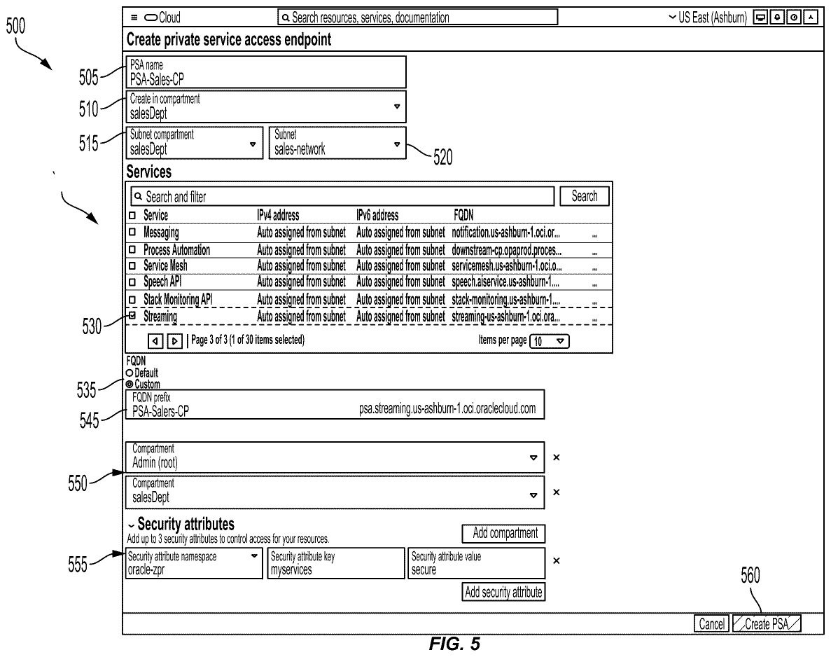

Creating a new PSA object may involve specifying the scope of the PSA object, such as the VCN 160 and the subnet/VNIC the PSA will be associated with. In some examples, the PSA object can be further scoped to other logical or physical divisions. For example, PSA objects can be scoped to particular “compartments,” which may be logical containers that segment resources within a CSP customer tenancy. The interface can be used to select a particular service included in service registry 230. The service registry 230 may be used to generate a “catalog” of available services to select from using the interface. Compartment scope, or other logical subdivisions, can be used to limit the services available to particular compartments. The PSA object can be further configured with an alias for name resolution purposes using a default or suggested FQDN associated with the service or a custom FQDN. The selected alias can be configured by adding one or more suitable entries to the DNS 150 of the VCN 160, as shown in FIG. 1. Additional configurations can be associated with new or existing PSA objects. Configuration and creation of PSA objects is discussed in further detail below in FIGS. 4 and 5.

The PSA objects 115A, 115B are created (or updated) by the PSA resource 225, shown in FIG. 2 using dashed lines. The PSA objects 115A, 115B can be accessed from compute instances in any private subnet in the VCN 160 as well as peered VCNs. In this regard, “peered” VCNs are networks with a route between them that does not traverse the public internet and remains within the CSPI 105. In some examples, the PSA objects 115A, 115B can also be accessed from workloads in “on-premise” physical servers or other hardware. This configuration can be effected by configuring a route from the on-premise hardware to the private IP address associated with the PSA object in the VCN 160.

The services 110A, 110B can be invoked from clients executing in compute instances such as command-line interfaces, programmatic clients, HTTP clients, and so on. When a client executing in a compute instance outputs a request to access a cloud service 110A from VCN 160, the request may be routed by to PSA object 115A via VNIC 120A. In FIG. 2, PSA routing 205A depicts schematically the routing of the request from the VNIC 120A through the CSPI 105 using, for example, internal route tables and network path virtualization to route packets entirely within the CSPI 105. PSA routing 205A can reflect the data plane operations implemented by CSPI 105 to direct packets from the VNIC 120A to the service 110A. The PSA object 115A may include a load balancer 210A that terminates incoming connections and forwards requests to service 110A to promote even distribution of network traffic and enable centralized control of routing within the CSPI 105. In some examples, the PSA object 115A may not include load balancer 210A and may route the request directly to the service 110A.

In some examples, the route to the service 110B may include a service platform 220. The service platform 220 may be middleware or API gateway that enables centralized control for services of functionality such as authentication, authorization, tag validation, auditing, quota/limit enforcement, and so on. Certain services (e.g., service 110B in FIG. 2) can be associated with the service platform 220 by way of a service platform service registry (not shown) that maintains a record of service 110B API specifications and other configuration data. For services associated with the service platform 220, when a client executing in a compute instance outputs a request to access such as a service 110B from VCN 160, the request may be routed by to PSA object 115A via VNIC 120A and PSA routing 205B, as described above. After being forwarded by the load balancer 210B, the service platform 220 acts as an API gateway for the service 110B, receiving and forwarding the request to the service 110B. In some examples, the PSA object 115B may not include load balancer 210B and may route the request directly to the service 110B via the service platform 220.

### Method for Providing a PSA

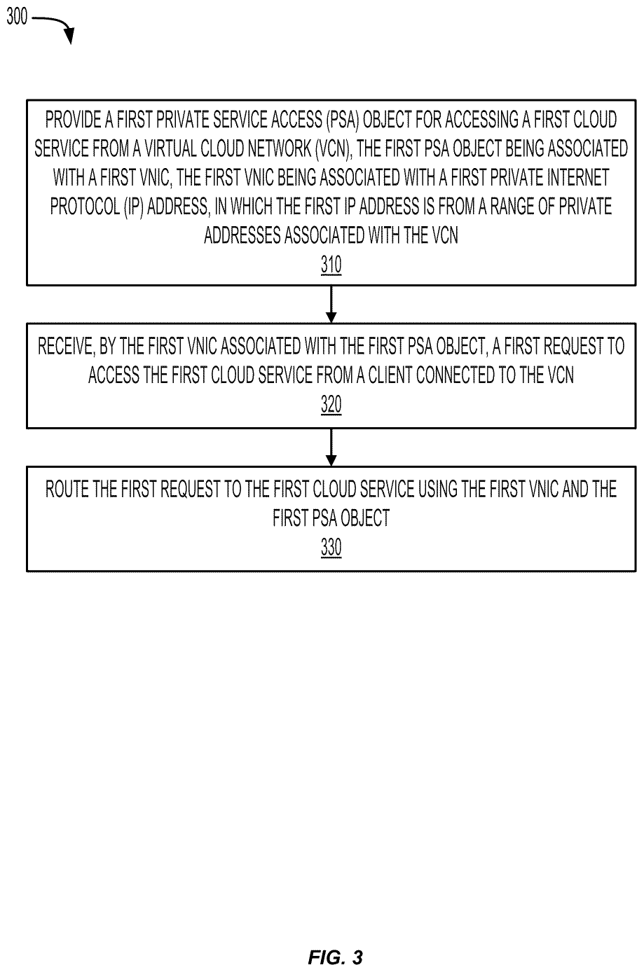

FIG. 3 shows a flowchart of an example method 300 for providing a PSA object for accessing a cloud service from a VCN, according to some aspects of the present disclosure. The description of the method 300 in FIG. 3 will be made with reference to FIGS. 1-2. It should be appreciated that method 300 provides a particular method for providing a PSA object for accessing a cloud service from a VCN. Other sequences of operations may also be performed according to alternative examples. For example, alternative examples of the present disclosure may perform the steps outlined below in a different order. Moreover, the individual operations illustrated by method 300 may include multiple sub-operations that may be performed in various sequences as appropriate to the individual operation. Furthermore, additional operations may be added or removed depending on the particular applications. The description is given from the perspective of a cloud computing environment such as the cloud computing environment 100 or 200 but other configurations are possible. One of ordinary skill in the art would recognize many variations, modifications, and alternatives.

In block 310, the cloud computing environment provides a first PSA object for accessing a first cloud service from a VCN, the first PSA object being associated with a first VNIC, the first VNIC being associated with a first private IP address, in which the first IP address is from a range of private addresses associated with the VCN. The range of private addresses may be associated with a private subnet included in the VCN. The first PSA object can be configured to provide access exclusively to the first cloud service, in contrast to existing approaches such as SGWs which enabled “all or none” access to cloud services using public IP addresses and resulting in attendant security and operational challenges due to the lack of fine-grained network traffic control.

For example, the first PSA object may be created or configured using the method described below in FIGS. 4 and 5. The first PSA object may be configured using the PSA resource 225, as described in FIG. 2. Once configuration is complete, including selection of a service from the service registry 230, the components of the first PSA object can be provisioned by the PSA resource and other CSPI 105 components. For instance, provisioning of PSA components may involve the creation or updating of internal CSPI 105 routing tables, instantiating a dedicated VNIC, configuring a load balancer or service platform, configuring internal CSPI 105 network paths, and so on. Once the first PSA object is created (or updated) a network administrator or engineer may receive an indication or notification indicating that the first PSA object is ready for use. For instance, the PSA resource may have an associated web-based GUI for creating or configuring the first PSA object. The GUI may display a notification (e.g., desktop notification) when the PSA object is created or updated.

In block 320, the cloud computing environment receives, by the first VNIC associated with the first PSA object, a first request to access the first cloud service from a client connected to the VCN. For example, the private subnet may include one or more compute instances that host applications, web services, databases, logging or monitoring software, and so on. A compute instance may communicate the first request to the first cloud service to, for example, send a command to a CSP service control plane implemented by the first cloud service. The first request to the first cloud service may be an API request to an API provided by the first cloud service. For instance, a compute instance may communicate a POST request to a cloud infrastructure control plane API to initiate the creation of an infrastructure stack defined using a domain-specific language (DSL), such as Terraform.

In some examples, the first PSA object may be configured with access restrictions to prevent data exfiltration attacks. For example, the first PSA object could be used by a malicious user to effect an unauthorized transfer of sensitive data from the VCN to the first cloud service instance. To prevent this attack, among other security concerns, the first PSA object can be, for example, limited such that it can only be accessed by principals local to the tenancy that the PSA belongs to. In this example, the first PSA object may be scoped to a particular customer tenancy. Because the customer may have multiple tenancies, the first PSA object can be configured such that only users associated with the particular tenancy can use the first PSA object to access the resource associated with the first cloud service. For instance, if a customer operates separate tenancies for development and production environments, the first PSA object can be configured to allow access only from users in the production tenancy, thereby preventing access to the first cloud service.

In block 330, the cloud computing environment routes the first request to the first cloud service using the first VNIC and the first PSA object. For example, the first request may be routed from the dedicated VNIC to a load balancer via CSPI provided by a CSP based on the configuration of the first PSA object. The CSPI configured for the first PSA object (e.g., PSA routing 205A, 205B in FIG. 2) may include routing tables, network links, security rules, etc. that gets the first request to the load balancer without traversing the public internet. The cloud computing environment can then route the first request from the load balancer the first cloud service, again using the CSPI.

In addition to sending requests to the first cloud service, the first PSA object can also be used to receive, from the first cloud service and via the first PSA object, a response to the first request. In this way, the first PSA object can be used for two-way, multiplexed traffic between compute instances on the VCN and the first cloud service.

For a given VCN, any number of PSAs can be provided. For example, the cloud computing environment can provide a second PSA object for accessing a second cloud service from the VCN, in which the second PSA object is associated with a second private IP address from the range of private addresses associated with the VCN. As described above, the cloud computing environment can receive a second request to access the second cloud service from the client connected to the VCN and route the second request to the second cloud service using the second PSA object, as well as responses from the second cloud service back to the originator of the second request. These steps can proceed substantially as described above with respect to blocks 310-330. However, the second PSA object is distinct from the first PSA object in that it has a dedicated VNIC, a different private IP address, and is associated with a different cloud service than the first PSA object.

### Method for Generating a PSA

FIG. 4 shows a flowchart of an example method 400 for providing a PSA object for accessing a cloud service from a VCN, according to some aspects of the present disclosure. The description of the method 400 in FIG. 4 will be made with reference to FIGS. 1-2. It should be appreciated that method 400 provides a particular method for providing a PSA object for accessing a cloud service from a VCN. Other sequences of operations may also be performed according to alternative examples. For example, alternative examples of the present disclosure may perform the steps outlined below in a different order. Moreover, the individual operations illustrated by method 400 may include multiple sub-operations that may be performed in various sequences as appropriate to the individual operation. Furthermore, additional operations may be added or removed depending on the particular applications. The description is given from the perspective of a cloud computing environment such as the cloud computing environment 100 or 200 but other configurations are possible. One of ordinary skill in the art would recognize many variations, modifications, and alternatives.

In block 410, the cloud computing environment receives a first indication of a selection of the first cloud service from a service catalog provided by a service registry (e.g., service registry 230) and configuration information for the first PSA object. For example, the service catalog may include various cloud services provided by the CSP that are registered with the service registry. Registration of cloud services with the service registry may involve, for example, providing the customer-facing service names, service endpoints (e.g., API IP addresses or IP addresses of API servers for cloud services that utilize the service platform API proxy), FQDNs or other aliases for APIs, and so on. The service registry may be maintained by the CSP and periodically updated (e.g., IP address or FQDN changes). The service registry may be further used to enforce adherence to the CSP API standards such as authentication/authorization requirements. In some examples, registered services can be configured with an informational message for CSP customer network engineers to review at PSA object creation, including information such as dependency warnings. The first indication may be generated in response to a selection made using a suitable GUI for PSA object creation, such as the example described below in FIG. 5.

In block 415, the cloud computing environment generates the first PSA object. Example method 400 shows several operations that can be used in one implementation of block 415. In block 420, the cloud computing environment allocates cloud network resources for the first PSA object. The first PSA object may include PSA routing components such as internal route tables, network path virtualization mechanisms (e.g., dynamic overlay routing, segment routing, VNICs, etc.) within the CSPI. The PSA routing components can be configured to maintain network traffic to and from the cloud service via the PSA object is efficiently conducted over the CSPI bypassing the public internet or other external networks. In some examples, the provisioned PSA object can be referred to as the PSA data plane.

In block 430, the cloud computing environment configures the first PSA object to enable access to the first cloud service using the configuration information for the first PSA object. The first PSA object can be configured in accordance with selections and configurations made when the first indication, described above, is received from a suitable GUI. Examples of such configurations are shown below in FIG. 5. Configurations for the first PSA object can include internal software-defined network (SDN) policies, security groups, rules, route tables, access control lists, network security groups, flow log settings, virtual test access point (VTAP) configurations, IP address management (e.g., custom IP address usage or static IP allocation), DNS mappings, network path analyzer configurations, security attributes, and so on.

In block 440, the cloud computing environment generates a VNIC for the VCN. The VNIC may be a virtualized, abstracted network interface that represents a logical attachment point for compute resources and other networking constructs, such as the first PSA object, within the VCN. The VNIC can be programmatically instantiated and managed by the CSP using a suitable API. The VNIC can be provisioned in accordance with the configurations described above in block 430. Some of the configurations described in block 430 may be implemented by the VNIC. In this respect the first PSA object includes characteristics of both the underlying PSA routing components as well as the dedicated VNIC configured in this block. The VNIC can be associated with a private subnet of the VCN (e.g., VNIC 120A and private subnet 130 in FIG. 1).

In block 450, the cloud computing environment associates the VNIC with the first PSA object to enable communications with the first cloud service. The association may be made, for example, in the internal routing tables used by the CSPI and may not be visible to CSP customers using the first PSA object via a compute instance attached to the respective private subnet of the VCN. This association ensures that the VNIC shares the first PSA object's configured network policies, routing logic, and security configurations, and so on, as described above.

In block 460, the cloud computing environment associates the private IP address with the VNIC. For example, the private IP address may be allocated from a user-provided pool associated with the private subnet or from statically reserved addresses available to the private subnet. Select private IP address can be bound to the VNIC using internal routing tables of the CSPI. Consequently, the configured network policies, security group memberships, monitoring hooks, etc. configured for the VNIC in block 450 apply to the associated private IP address.

### User Interface for Configuring a PSA

FIG. 5 depicts a graphical user interface (“UGI”) 500 for configuring a PSA object for accessing a cloud service from a VCN, according to some aspects of the present disclosure. The GUI 500 includes a number of UI controls and inputs that can be used to configure various aspects of the PSA object that will be implemented by the PSA object itself, its underlying components, its dedicated VNIC, or related components such as local DNS configurations.

Input box 505 can be used to input a name for the PSA object. The name for the PSA object may be used to reference the PSA object in configuration screens and may not be machine readable. For example, the PSA object name may include characters that are unsuitable for use in FQDNs. Selector 510 can be used to select a compartment or other logical subdivision in which the PSA object should be created. A compartment can refer to a logical, administrative subdivision of a tenancy for a CSP customer. Similarly, selector 515 can be used to select the compartment or other logical subdivision with which the private subnet the PSA object will be associated with should reside. The selector 520 can then be used to select the private subnet. The private subnets shown in the selector 520 may be narrowed according to the selection made using selector 515. The compartment associated with the PSA object may differ from the compartment associated with the private subnet, in which case the access controls for each respective subnet must be satisfied by workloads attempting to use the PSA object.

The service catalog 525 shows a list of cloud services configured with a service registry (e.g., service registry 230 of FIG. 2). Checkbox 530 is used to select the particular cloud service that will be associated with the configured PSA object. In this example, a “Streaming” cloud service is selected. The service catalog 525 can show additional information such as default IP address settings, default FQDNs, and other information. The radio selector 535 can be used to specify whether to use the default FQDN or a custom name. In the case that a custom name is indicated using radio selector 535, the custom name can be specified using input box 545. In this example, the input box 545 allows for input of a custom prefix to a fixed FQDN. In some examples, the input box 545 may allow for input of additional portions of or the entire FQDN. Selectors 550 can be used for specification of additional compartments or other logical subdivisions to associate with the PSA object.

Selectors 555 can be used to configure security rules via security attributes. For example, selectors 555 can be used to specify one or more security attributes using namespace, key, and value triplets that can cause PSA object network traffic to be permitted or denied based on explicit, context-aware criteria. For example, selectors 555 can be used to specify a security rule with namespace “networkZone,” key “classification,” and value “restricted” to require that only network traffic originating from resources explicitly tagged as belonging to the “restricted” zone is allowed to transit the PSA object.

### Method for Using a PSA

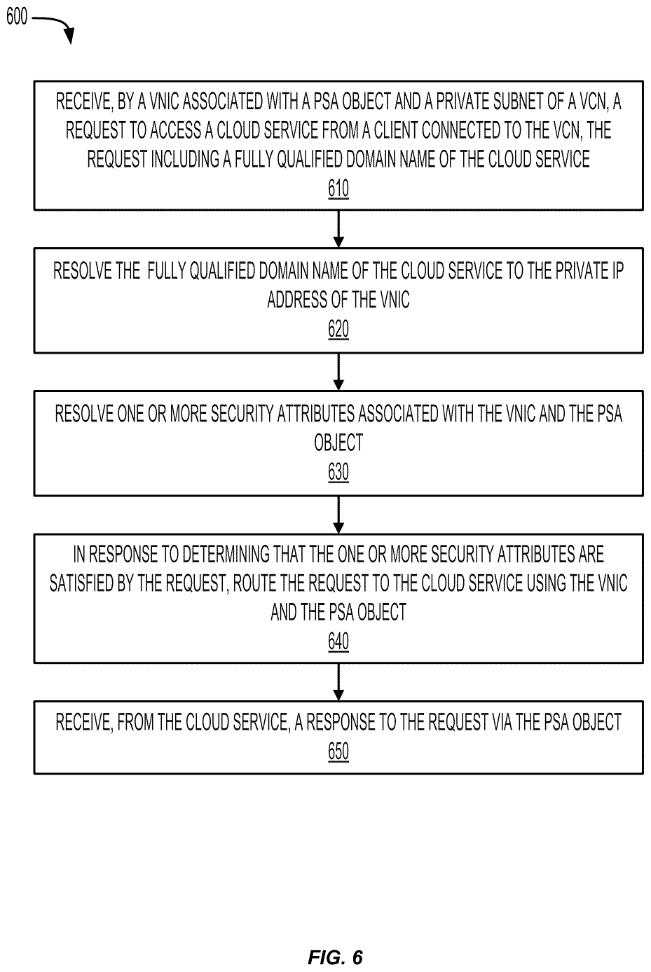

FIG. 6 shows a flowchart of an example method 600 for using a PSA object for accessing a cloud service from a VCN, according to some aspects of the present disclosure. The description of the method 600 in FIG. 6 will be made with reference to FIGS. 1-2. It should be appreciated that method 600 provides a particular method for using a PSA object for accessing a cloud service from a VCN. Other sequences of operations may also be performed according to alternative examples. For example, alternative examples of the present disclosure may perform the steps outlined below in a different order. Moreover, the individual operations illustrated by method 600 may include multiple sub-operations that may be performed in various sequences as appropriate to the individual operation. Furthermore, additional operations may be added or removed depending on the particular applications. The description is given from the perspective of a cloud computing environment such as the cloud computing environment 100 or 200 but other configurations are possible. One of ordinary skill in the art would recognize many variations, modifications, and alternatives.

In block 610, the cloud computing environment receives, by a VNIC associated with a PSA object and a private subnet of a VCN, a request to access a cloud service from a client connected to the VCN, the request including a fully qualified domain name of the cloud service. For example, the cloud service APIs may be invoked using clients or access methods including command line clients provided by the CSP, native HTTP clients, infrastructure-as-code provisioning tools, CSP-provided dashboards or UIs, and so on. These client examples may effectively “wrap” the cloud service endpoint associated with the PSA object.

In block 620, the cloud computing environment resolves the fully qualified domain name of the cloud service to the private IP address of the VNIC. For example, the PSA object may be configured with an alias for name resolution purposes using a default or suggested FQDN associated with the cloud service or a custom customer-selected FQDN. A DNS service associated with the VCN can be configured to resolve the fully qualified domain name to the private IP address of the VNIC. In some examples, the fully qualified domain name may include a prefix (e.g., “example.cloud.service-1.psa”) to indicate that it is associated with the PSA object.

In block 630, the cloud computing environment resolves one or more security attributes associated with the VNIC and the PSA object. For example, the VNIC may be configured with one or more security attributes to permit or deny network traffic through the first PSA object. The security attributes may include virtual firewall rules such as security lists or “network security groups” that define ingress and egress traffic policies. The security attributes can effectively define rules that are enforced at by the VNIC level and evaluated before traffic is allowed to traverse the route to the cloud service via the PSA object.

In block 640, the cloud computing environment, in response to determining that the one or more security attributes are satisfied by the request, routes the request to the cloud service using the VNIC and the PSA object. This block can proceed substantially as described with respect to block 330 of FIG. 3 above.

In block 650, the cloud computing environment receives, from the cloud service, a response to the request via the PSA object. In this way, the PSA object can be used for two-way, multiplexed traffic between the client executing on the VCN and the cloud service.

### Example Cloud Computing Environment

As noted above, infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand)) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

FIG. 7 is a block diagram 700 illustrating an example pattern of an IaaS architecture, according to at least one embodiment. Service operators 702 can be communicatively coupled to a secure host tenancy 704 that can include a virtual cloud network (VCN) 706 and a secure host subnet 708. In some examples, the service operators 702 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 706 and/or the Internet.

The VCN 706 can include a local peering gateway (LPG) 710 that can be communicatively coupled to a secure shell (SSH) VCN 712 via an LPG 710 contained in the SSH VCN 712. The SSH VCN 712 can include an SSH subnet 714, and the SSH VCN 712 can be communicatively coupled to a control plane VCN 716 via the LPG 710 contained in the control plane VCN 716. Also, the SSH VCN 712 can be communicatively coupled to a data plane VCN 718 via an LPG 710. The control plane VCN 716 and the data plane VCN 718 can be contained in a service tenancy 719 that can be owned and/or operated by the IaaS provider.

The control plane VCN 716 can include a control plane demilitarized zone (DMZ) tier 720 that acts as a perimeter network (e.g., portions of a corporate network between the corporate intranet and external networks). The DMZ-based servers may have restricted responsibilities and help keep breaches contained. Additionally, the DMZ tier 720 can include one or more load balancer (LB) subnet(s) 722, a control plane app tier 724 that can include app subnet(s) 726, a control plane data tier 728 that can include database (DB) subnet(s) 730 (e.g., frontend DB subnet(s) and/or backend DB subnet(s)). The LB subnet(s) 722 contained in the control plane DMZ tier 720 can be communicatively coupled to the app subnet(s) 726 contained in the control plane app tier 724 and an Internet gateway 734 that can be contained in the control plane VCN 716, and the app subnet(s) 726 can be communicatively coupled to the DB subnet(s) 730 contained in the control plane data tier 728 and a service gateway 736 and a network address translation (NAT) gateway 738. The control plane VCN 716 can include the service gateway 736 and the NAT gateway 738.

The control plane VCN 716 can include a data plane mirror app tier 740 that can include app subnet(s) 726. The app subnet(s) 726 contained in the data plane mirror app tier 740 can include a virtual network interface controller (VNIC) 742 that can execute a compute instance 744. The compute instance 744 can communicatively couple the app subnet(s) 726 of the data plane mirror app tier 740 to app subnet(s) 726 that can be contained in a data plane app tier 746.

The data plane VCN 718 can include the data plane app tier 746, a data plane DMZ tier 748, and a data plane data tier 750. The data plane DMZ tier 748 can include LB subnet(s) 722 that can be communicatively coupled to the app subnet(s) 726 of the data plane app tier 746 and the Internet gateway 734 of the data plane VCN 718. The app subnet(s) 726 can be communicatively coupled to the service gateway 736 of the data plane VCN 718 and the NAT gateway 738 of the data plane VCN 718. The data plane data tier 750 can also include the DB subnet(s) 730 that can be communicatively coupled to the app subnet(s) 726 of the data plane app tier 746.

The Internet gateway 734 of the control plane VCN 716 and of the data plane VCN 718 can be communicatively coupled to a metadata management service 752 that can be communicatively coupled to public Internet 754. Public Internet 754 can be communicatively coupled to the NAT gateway 738 of the control plane VCN 716 and of the data plane VCN 718. The service gateway 736 of the control plane VCN 716 and of the data plane VCN 718 can be communicatively coupled to cloud services 756.

In some examples, the service gateway 736 of the control plane VCN 716 or of the data plane VCN 718 can make application programming interface (API) calls to cloud services 756 without going through public Internet 754. The API calls to cloud services 756 from the service gateway 736 can be one-way: the service gateway 736 can make API calls to cloud services 756, and cloud services 756 can send requested data to the service gateway 736. But, cloud services 756 may not initiate API calls to the service gateway 736.

In some examples, the secure host tenancy 704 can be directly connected to the service tenancy 719, which may be otherwise isolated. The secure host subnet 708 can communicate with the SSH subnet 714 through an LPG 710 that may enable two-way communication over an otherwise isolated system. Connecting the secure host subnet 708 to the SSH subnet 714 may give the secure host subnet 708 access to other entities within the service tenancy 719.

The control plane VCN 716 may allow users of the service tenancy 719 to set up or otherwise provision desired resources. Desired resources provisioned in the control plane VCN 716 may be deployed or otherwise used in the data plane VCN 718. In some examples, the control plane VCN 716 can be isolated from the data plane VCN 718, and the data plane mirror app tier 740 of the control plane VCN 716 can communicate with the data plane app tier 746 of the data plane VCN 718 via VNICs 742 that can be contained in the data plane mirror app tier 740 and the data plane app tier 746.

In some examples, users of the system, or customers, can make requests, for example create, read, update, or delete (CRUD) operations, through public Internet 754 that can communicate the requests to the metadata management service 752. The metadata management service 752 can communicate the request to the control plane VCN 716 through the Internet gateway 734. The request can be received by the LB subnet(s) 722 contained in the control plane DMZ tier 720. The LB subnet(s) 722 may determine that the request is valid, and in response to this determination, the LB subnet(s) 722 can transmit the request to app subnet(s) 726 contained in the control plane app tier 724. If the request is validated and requires a call to public Internet 754, the call to public Internet 754 may be transmitted to the NAT gateway 738 that can make the call to public Internet 754. Metadata that may be desired to be stored by the request can be stored in the DB subnet(s) 730.

In some examples, the data plane mirror app tier 740 can facilitate direct communication between the control plane VCN 716 and the data plane VCN 718. For example, changes, updates, or other suitable modifications to configuration may be desired to be applied to the resources contained in the data plane VCN 718. Via a VNIC 742, the control plane VCN 716 can directly communicate with, and can thereby execute the changes, updates, or other suitable modifications to configuration to, resources contained in the data plane VCN 718.

In some embodiments, the control plane VCN 716 and the data plane VCN 718 can be contained in the service tenancy 719. In this case, the user, or the customer, of the system may not own or operate either the control plane VCN 716 or the data plane VCN 718. Instead, the IaaS provider may own or operate the control plane VCN 716 and the data plane VCN 718, both of which may be contained in the service tenancy 719. This embodiment can enable isolation of networks that may prevent users or customers from interacting with other users', or other customers', resources. Also, this embodiment may allow users or customers of the system to store databases privately without needing to rely on public Internet 754, which may not have a desired level of threat prevention, for storage.

In other embodiments, the LB subnet(s) 722 contained in the control plane VCN 716 can be configured to receive a signal from the service gateway 736. In this embodiment, the control plane VCN 716 and the data plane VCN 718 may be configured to be called by a customer of the IaaS provider without calling public Internet 754. Customers of the IaaS provider may desire this embodiment since database(s) that the customers use may be controlled by the IaaS provider and may be stored on the service tenancy 719, which may be isolated from public Internet 754.

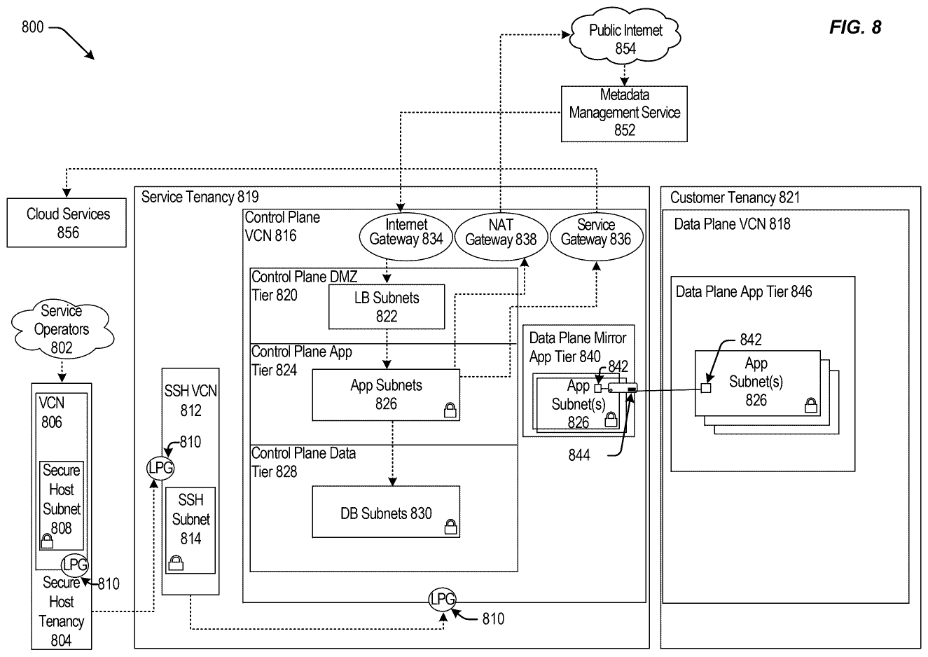

FIG. 8 is a block diagram 800 illustrating another example pattern of an IaaS architecture, according to at least one embodiment. Service operators 802 (e.g., service operators 702 of FIG. 7) can be communicatively coupled to a secure host tenancy 804 (e.g., the secure host tenancy 704 of FIG. 7) that can include a virtual cloud network (VCN) 806 (e.g., the VCN 706 of FIG. 7) and a secure host subnet 808 (e.g., the secure host subnet 708 of FIG. 7). The VCN 806 can include a local peering gateway (LPG) 810 (e.g., the LPG 710 of FIG. 7) that can be communicatively coupled to a secure shell (SSH) VCN 812 (e.g., the SSH VCN 712 of FIG. 7) via an LPG 710 contained in the SSH VCN 812. The SSH VCN 812 can include an SSH subnet 814 (e.g., the SSH subnet 714 of FIG. 7), and the SSH VCN 812 can be communicatively coupled to a control plane VCN 816 (e.g., the control plane VCN 716 of FIG. 7) via an LPG 810 contained in the control plane VCN 816. The control plane VCN 816 can be contained in a service tenancy 819 (e.g., the service tenancy 719 of FIG. 7), and the data plane VCN 818 (e.g., the data plane VCN 718 of FIG. 7) can be contained in a customer tenancy 821 that may be owned or operated by users, or customers, of the system.

The control plane VCN 816 can include a control plane DMZ tier 820 (e.g., the control plane DMZ tier 720 of FIG. 7) that can include LB subnet(s) 822 (e.g., LB subnet(s) 722 of FIG. 7), a control plane app tier 824 (e.g., the control plane app tier 724 of FIG. 7) that can include app subnet(s) 826 (e.g., app subnet(s) 726 of FIG. 7), a control plane data tier 828 (e.g., the control plane data tier 728 of FIG. 7) that can include database (DB) subnet(s) 830 (e.g., similar to DB subnet(s) 730 of FIG. 7). The LB subnet(s) 822 contained in the control plane DMZ tier 820 can be communicatively coupled to the app subnet(s) 826 contained in the control plane app tier 824 and an Internet gateway 834 (e.g., the Internet gateway 734 of FIG. 7) that can be contained in the control plane VCN 816, and the app subnet(s) 826 can be communicatively coupled to the DB subnet(s) 830 contained in the control plane data tier 828 and a service gateway 836 (e.g., the service gateway 736 of FIG. 7) and a network address translation (NAT) gateway 838 (e.g., the NAT gateway 738 of FIG. 7). The control plane VCN 816 can include the service gateway 836 and the NAT gateway 838.

The control plane VCN 816 can include a data plane mirror app tier 840 (e.g., the data plane mirror app tier 740 of FIG. 7) that can include app subnet(s) 826. The app subnet(s) 826 contained in the data plane mirror app tier 840 can include a virtual network interface controller (VNIC) 842 (e.g., the VNIC of 742) that can execute a compute instance 844 (e.g., similar to the compute instance 744 of FIG. 7). The compute instance 844 can facilitate communication between the app subnet(s) 826 of the data plane mirror app tier 840 and the app subnet(s) 826 that can be contained in a data plane app tier 846 (e.g., the data plane app tier 746 of FIG. 7) via the VNIC 842 contained in the data plane mirror app tier 840 and the VNIC 842 contained in the data plane app tier 846.

The Internet gateway 834 contained in the control plane VCN 816 can be communicatively coupled to a metadata management service 852 (e.g., the metadata management service 752 of FIG. 7) that can be communicatively coupled to public Internet 854 (e.g., public Internet 754 of FIG. 7). Public Internet 854 can be communicatively coupled to the NAT gateway 838 contained in the control plane VCN 816. The service gateway 836 contained in the control plane VCN 816 can be communicatively coupled to cloud services 856 (e.g., cloud services 756 of FIG. 7).

In some examples, the data plane VCN 818 can be contained in the customer tenancy 821. In this case, the IaaS provider may provide the control plane VCN 816 for each customer, and the IaaS provider may, for each customer, set up a unique compute instance 844 that is contained in the service tenancy 819. Each compute instance 844 may allow communication between the control plane VCN 816, contained in the service tenancy 819, and the data plane VCN 818 that is contained in the customer tenancy 821. The compute instance 844 may allow resources, that are provisioned in the control plane VCN 816 that is contained in the service tenancy 819, to be deployed or otherwise used in the data plane VCN 818 that is contained in the customer tenancy 821.

In other examples, the customer of the IaaS provider may have databases that live in the customer tenancy 821. In this example, the control plane VCN 816 can include the data plane mirror app tier 840 that can include app subnet(s) 826. The data plane mirror app tier 840 can reside in the data plane VCN 818, but the data plane mirror app tier 840 may not live in the data plane VCN 818. That is, the data plane mirror app tier 840 may have access to the customer tenancy 821, but the data plane mirror app tier 840 may not exist in the data plane VCN 818 or be owned or operated by the customer of the IaaS provider. The data plane mirror app tier 840 may be configured to make calls to the data plane VCN 818 but may not be configured to make calls to any entity contained in the control plane VCN 816. The customer may desire to deploy or otherwise use resources in the data plane VCN 818 that are provisioned in the control plane VCN 816, and the data plane mirror app tier 840 can facilitate the desired deployment, or other usage of resources, of the customer.

In some embodiments, the customer of the IaaS provider can apply filters to the data plane VCN 818. In this embodiment, the customer can determine what the data plane VCN 818 can access, and the customer may restrict access to public Internet 854 from the data plane VCN 818. The IaaS provider may not be able to apply filters or otherwise control access of the data plane VCN 818 to any outside networks or databases. Applying filters and controls by the customer onto the data plane VCN 818, contained in the customer tenancy 821, can help isolate the data plane VCN 818 from other customers and from public Internet 854.

In some embodiments, cloud services 856 can be called by the service gateway 836 to access services that may not exist on public Internet 854, on the control plane VCN 816, or on the data plane VCN 818. The connection between cloud services 856 and the control plane VCN 816 or the data plane VCN 818 may not be live or continuous. Cloud services 856 may exist on a different network owned or operated by the IaaS provider. Cloud services 856 may be configured to receive calls from the service gateway 836 and may be configured to not receive calls from public Internet 854. Some cloud services 856 may be isolated from other cloud services 856, and the control plane VCN 816 may be isolated from cloud services 856 that may not be in the same region as the control plane VCN 816. For example, the control plane VCN 816 may be located in “Region 1,” and cloud service “Deployment 7,” may be located in Region 1 and in “Region 2.” If a call to Deployment 7 is made by the service gateway 836 contained in the control plane VCN 816 located in Region 1, the call may be transmitted to Deployment 7 in Region 1. In this example, the control plane VCN 816, or Deployment 7 in Region 1, may not be communicatively coupled to, or otherwise in communication with, Deployment 7 in Region 2.

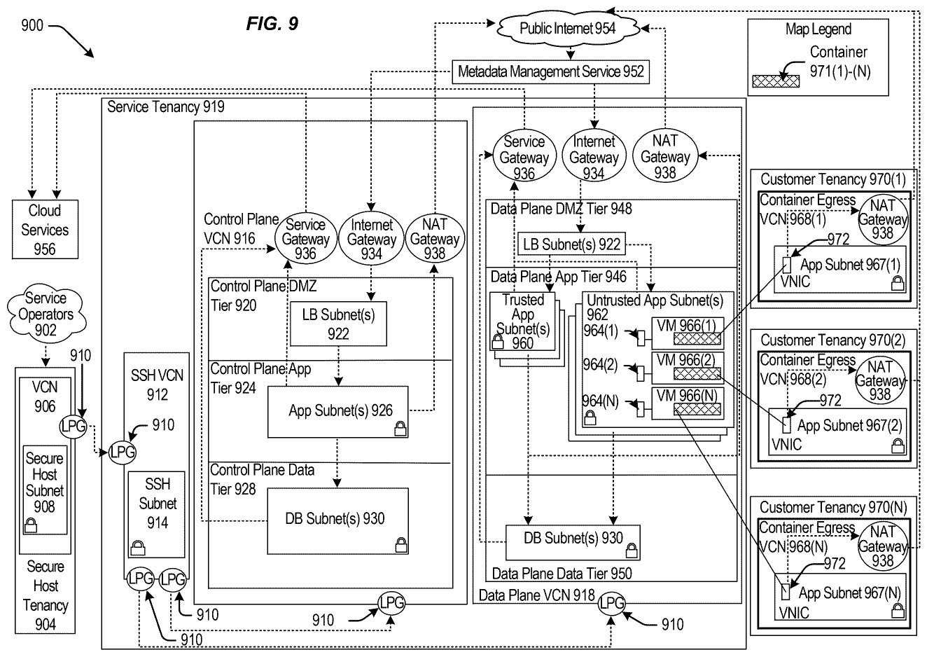

FIG. 9 is a block diagram 900 illustrating another example pattern of an IaaS architecture, according to at least one embodiment. Service operators 902 (e.g., service operators 702 of FIG. 7) can be communicatively coupled to a secure host tenancy 904 (e.g., the secure host tenancy 704 of FIG. 7) that can include a virtual cloud network (VCN) 906 (e.g., the VCN 706 of FIG. 7) and a secure host subnet 908 (e.g., the secure host subnet 708 of FIG. 7). The VCN 906 can include an LPG 910 (e.g., the LPG 710 of FIG. 7) that can be communicatively coupled to an SSH VCN 912 (e.g., the SSH VCN 712 of FIG. 7) via an LPG 910 contained in the SSH VCN 912. The SSH VCN 912 can include an SSH subnet 914 (e.g., the SSH subnet 714 of FIG. 7), and the SSH VCN 912 can be communicatively coupled to a control plane VCN 916 (e.g., the control plane VCN 716 of FIG. 7) via an LPG 910 contained in the control plane VCN 916 and to a data plane VCN 918 (e.g., the data plane 718 of FIG. 7) via an LPG 910 contained in the data plane VCN 918. The control plane VCN 916 and the data plane VCN 918 can be contained in a service tenancy 919 (e.g., the service tenancy 719 of FIG. 7).

The control plane VCN 916 can include a control plane DMZ tier 920 (e.g., the control plane DMZ tier 720 of FIG. 7) that can include load balancer (LB) subnet(s) 922 (e.g., LB subnet(s) 722 of FIG. 7), a control plane app tier 924 (e.g., the control plane app tier 724 of FIG. 7) that can include app subnet(s) 926 (e.g., similar to app subnet(s) 726 of FIG. 7), a control plane data tier 928 (e.g., the control plane data tier 728 of FIG. 7) that can include DB subnet(s) 930. The LB subnet(s) 922 contained in the control plane DMZ tier 920 can be communicatively coupled to the app subnet(s) 926 contained in the control plane app tier 924 and to an Internet gateway 934 (e.g., the Internet gateway 734 of FIG. 7) that can be contained in the control plane VCN 916, and the app subnet(s) 926 can be communicatively coupled to the DB subnet(s) 930 contained in the control plane data tier 928 and to a service gateway 936 (e.g., the service gateway of FIG. 7) and a network address translation (NAT) gateway 938 (e.g., the NAT gateway 738 of FIG. 7). The control plane VCN 916 can include the service gateway 936 and the NAT gateway 938.

The data plane VCN 918 can include a data plane app tier 946 (e.g., the data plane app tier 746 of FIG. 7), a data plane DMZ tier 948 (e.g., the data plane DMZ tier 748 of FIG. 7), and a data plane data tier 950 (e.g., the data plane data tier 750 of FIG. 7). The data plane DMZ tier 948 can include LB subnet(s) 922 that can be communicatively coupled to trusted app subnet(s) 960 and untrusted app subnet(s) 962 of the data plane app tier 946 and the Internet gateway 934 contained in the data plane VCN 918. The trusted app subnet(s) 960 can be communicatively coupled to the service gateway 936 contained in the data plane VCN 918, the NAT gateway 938 contained in the data plane VCN 918, and DB subnet(s) 930 contained in the data plane data tier 950. The untrusted app subnet(s) 962 can be communicatively coupled to the service gateway 936 contained in the data plane VCN 918 and DB subnet(s) 930 contained in the data plane data tier 950. The data plane data tier 950 can include DB subnet(s) 930 that can be communicatively coupled to the service gateway 936 contained in the data plane VCN 918.

The untrusted app subnet(s) 962 can include one or more primary VNICs 964(1)-(N) that can be communicatively coupled to tenant virtual machines (VMs) 966(1)-(N). Each tenant VM 966(1)-(N) can be communicatively coupled to a respective app subnet 967(1)-(N) that can be contained in respective container egress VCNs 968(1)-(N) that can be contained in respective customer tenancies 970(1)-(N). Respective secondary VNICs 972(1)-(N) can facilitate communication between the untrusted app subnet(s) 962 contained in the data plane VCN 918 and the app subnet contained in the container egress VCNs 968(1)-(N). Each container egress VCNs 968(1)-(N) can include a NAT gateway 938 that can be communicatively coupled to public Internet 954 (e.g., public Internet 754 of FIG. 7).

The Internet gateway 934 contained in the control plane VCN 916 and contained in the data plane VCN 918 can be communicatively coupled to a metadata management service 952 (e.g., the metadata management system 752 of FIG. 7) that can be communicatively coupled to public Internet 954. Public Internet 954 can be communicatively coupled to the NAT gateway 938 contained in the control plane VCN 916 and contained in the data plane VCN 918. The service gateway 936 contained in the control plane VCN 916 and contained in the data plane VCN 918 can be communicatively coupled to cloud services 956.

In some embodiments, the data plane VCN 918 can be integrated with customer tenancies 970. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 946. Code to run the function may be executed in the VMs 966(1)-(N), and the code may not be configured to run anywhere else on the data plane VCN 918. Each VM 966(1)-(N) may be connected to one customer tenancy 970. Respective containers 971(1)-(N) contained in the VMs 966(1)-(N) may be configured to run the code. In this case, there can be a dual isolation (e.g., the containers 971(1)-(N) running code, where the containers 971(1)-(N) may be contained in at least the VM 966(1)-(N) that are contained in the untrusted app subnet(s) 962), which may help prevent incorrect or otherwise undesirable code from damaging the network of the IaaS provider or from damaging a network of a different customer. The containers 971(1)-(N) may be communicatively coupled to the customer tenancy 970 and may be configured to transmit or receive data from the customer tenancy 970. The containers 971(1)-(N) may not be configured to transmit or receive data from any other entity in the data plane VCN 918. Upon completion of running the code, the IaaS provider may kill or otherwise dispose of the containers 971(1)-(N).

In some embodiments, the trusted app subnet(s) 960 may run code that may be owned or operated by the IaaS provider. In this embodiment, the trusted app subnet(s) 960 may be communicatively coupled to the DB subnet(s) 930 and be configured to execute CRUD operations in the DB subnet(s) 930. The untrusted app subnet(s) 962 may be communicatively coupled to the DB subnet(s) 930, but in this embodiment, the untrusted app subnet(s) may be configured to execute read operations in the DB subnet(s) 930. The containers 971(1)-(N) that can be contained in the VM 966(1)-(N) of each customer and that may run code from the customer may not be communicatively coupled with the DB subnet(s) 930.

In other embodiments, the control plane VCN 916 and the data plane VCN 918 may not be directly communicatively coupled. In this embodiment, there may be no direct communication between the control plane VCN 916 and the data plane VCN 918. However, communication can occur indirectly through at least one method. An LPG 910 may be established by the IaaS provider that can facilitate communication between the control plane VCN 916 and the data plane VCN 918. In another example, the control plane VCN 916 or the data plane VCN 918 can make a call to cloud services 956 via the service gateway 936. For example, a call to cloud services 956 from the control plane VCN 916 can include a request for a service that can communicate with the data plane VCN 918.

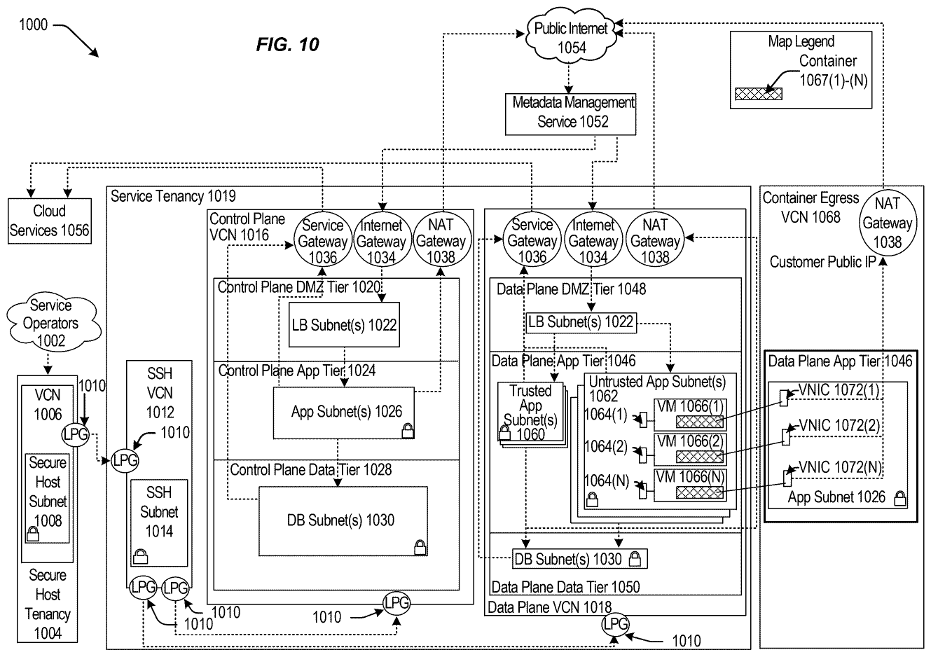

FIG. 10 is a block diagram 1000 illustrating another example pattern of an IaaS architecture, according to at least one embodiment. Service operators 1002 (e.g., service operators 702 of FIG. 7) can be communicatively coupled to a secure host tenancy 1004 (e.g., the secure host tenancy 704 of FIG. 7) that can include a virtual cloud network (VCN) 1006 (e.g., the VCN 706 of FIG. 7) and a secure host subnet 1008 (e.g., the secure host subnet 708 of FIG. 7). The VCN 1006 can include an LPG 1010 (e.g., the LPG 710 of FIG. 7) that can be communicatively coupled to an SSH VCN 1012 (e.g., the SSH VCN 712 of FIG. 7) via an LPG 1010 contained in the SSH VCN 1012. The SSH VCN 1012 can include an SSH subnet 1014 (e.g., the SSH subnet 714 of FIG. 7), and the SSH VCN 1012 can be communicatively coupled to a control plane VCN 1016 (e.g., the control plane VCN 716 of FIG. 7) via an LPG 1010 contained in the control plane VCN 1016 and to a data plane VCN 1018 (e.g., the data plane 718 of FIG. 7) via an LPG 1010 contained in the data plane VCN 1018. The control plane VCN 1016 and the data plane VCN 1018 can be contained in a service tenancy 1019 (e.g., the service tenancy 719 of FIG. 7).

The control plane VCN 1016 can include a control plane DMZ tier 1020 (e.g., the control plane DMZ tier 720 of FIG. 7) that can include LB subnet(s) 1022 (e.g., LB subnet(s) 722 of FIG. 7), a control plane app tier 1024 (e.g., the control plane app tier 724 of FIG. 7) that can include app subnet(s) 1026 (e.g., app subnet(s) 726 of FIG. 7), a control plane data tier 1028 (e.g., the control plane data tier 728 of FIG. 7) that can include DB subnet(s) 1030 (e.g., DB subnet(s) 930 of FIG. 9). The LB subnet(s) 1022 contained in the control plane DMZ tier 1020 can be communicatively coupled to the app subnet(s) 1026 contained in the control plane app tier 1024 and to an Internet gateway 1034 (e.g., the Internet gateway 734 of FIG. 7) that can be contained in the control plane VCN 1016, and the app subnet(s) 1026 can be communicatively coupled to the DB subnet(s) 1030 contained in the control plane data tier 1028 and to a service gateway 1036 (e.g., the service gateway of FIG. 7) and a network address translation (NAT) gateway 1038 (e.g., the NAT gateway 738 of FIG. 7). The control plane VCN 1016 can include the service gateway 1036 and the NAT gateway 1038.

The data plane VCN 1018 can include a data plane app tier 1046 (e.g., the data plane app tier 746 of FIG. 7), a data plane DMZ tier 1048 (e.g., the data plane DMZ tier 748 of FIG. 7), and a data plane data tier 1050 (e.g., the data plane data tier 750 of FIG. 7). The data plane DMZ tier 1048 can include LB subnet(s) 1022 that can be communicatively coupled to trusted app subnet(s) 1060 (e.g., trusted app subnet(s) 960 of FIG. 9) and untrusted app subnet(s) 1062 (e.g., untrusted app subnet(s) 962 of FIG. 9) of the data plane app tier 1046 and the Internet gateway 1034 contained in the data plane VCN 1018. The trusted app subnet(s) 1060 can be communicatively coupled to the service gateway 1036 contained in the data plane VCN 1018, the NAT gateway 1038 contained in the data plane VCN 1018, and DB subnet(s) 1030 contained in the data plane data tier 1050. The untrusted app subnet(s) 1062 can be communicatively coupled to the service gateway 1036 contained in the data plane VCN 1018 and DB subnet(s) 1030 contained in the data plane data tier 1050. The data plane data tier 1050 can include DB subnet(s) 1030 that can be communicatively coupled to the service gateway 1036 contained in the data plane VCN 1018.

The untrusted app subnet(s) 1062 can include primary VNICs 1064(1)-(N) that can be communicatively coupled to tenant virtual machines (VMs) 1066(1)-(N) residing within the untrusted app subnet(s) 1062. Each tenant VM 1066(1)-(N) can run code in a respective container 1067(1)-(N), and be communicatively coupled to an app subnet 1026 that can be contained in a data plane app tier 1046 that can be contained in a container egress VCN 1068. Respective secondary VNICs 1072(1)-(N) can facilitate communication between the untrusted app subnet(s) 1062 contained in the data plane VCN 1018 and the app subnet contained in the container egress VCN 1068. The container egress VCN can include a NAT gateway 1038 that can be communicatively coupled to public Internet 1054 (e.g., public Internet 754 of FIG. 7).

The Internet gateway 1034 contained in the control plane VCN 1016 and contained in the data plane VCN 1018 can be communicatively coupled to a metadata management service 1052 (e.g., the metadata management system 752 of FIG. 7) that can be communicatively coupled to public Internet 1054. Public Internet 1054 can be communicatively coupled to the NAT gateway 1038 contained in the control plane VCN 1016 and contained in the data plane VCN 1018. The service gateway 1036 contained in the control plane VCN 1016 and contained in the data plane VCN 1018 can be communicatively coupled to cloud services 1056.

In some examples, the pattern illustrated by the architecture of block diagram 1000 of FIG. 10 may be considered an exception to the pattern illustrated by the architecture of block diagram 900 of FIG. 9 and may be desirable for a customer of the IaaS provider if the IaaS provider cannot directly communicate with the customer (e.g., a disconnected region). The respective containers 1067(1)-(N) that are contained in the VMs 1066(1)-(N) for each customer can be accessed in real-time by the customer. The containers 1067(1)-(N) may be configured to make calls to respective secondary VNICs 1072(1)-(N) contained in app subnet(s) 1026 of the data plane app tier 1046 that can be contained in the container egress VCN 1068. The secondary VNICs 1072(1)-(N) can transmit the calls to the NAT gateway 1038 that may transmit the calls to public Internet 1054. In this example, the containers 1067(1)-(N) that can be accessed in real-time by the customer can be isolated from the control plane VCN 1016 and can be isolated from other entities contained in the data plane VCN 1018. The containers 1067(1)-(N) may also be isolated from resources from other customers.

In other examples, the customer can use the containers 1067(1)-(N) to call cloud services 1056. In this example, the customer may run code in the containers 1067(1)-(N) that requests a service from cloud services 1056. The containers 1067(1)-(N) can transmit this request to the secondary VNICs 1072(1)-(N) that can transmit the request to the NAT gateway that can transmit the request to public Internet 1054. Public Internet 1054 can transmit the request to LB subnet(s) 1022 contained in the control plane VCN 1016 via the Internet gateway 1034. In response to determining the request is valid, the LB subnet(s) can transmit the request to app subnet(s) 1026 that can transmit the request to cloud services 1056 via the service gateway 1036.

It should be appreciated that IaaS architectures 700, 800, 900, 1000 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

FIG. 11 illustrates an example computer system 1100, in which various embodiments may be implemented. The system 1100 may be used to implement any of the computer systems described above. As shown in the figure, computer system 1100 includes a processing unit 1104 that communicates with a number of peripheral subsystems via a bus subsystem 1102. These peripheral subsystems may include a processing acceleration unit 1106, an I/O subsystem 1108, a storage subsystem 1118 and a communications subsystem 1124. Storage subsystem 1118 includes tangible computer-readable storage media 1122 and a system memory 1110.

Bus subsystem 1102 provides a mechanism for letting the various components and subsystems of computer system 1100 communicate with each other as intended. Although bus subsystem 1102 is shown schematically as a single bus, alternative embodiments of the bus subsystem may utilize multiple buses. Bus subsystem 1102 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1104, which can be implemented as one or more integrated circuits (e.g., a conventional microprocessor or microcontroller), controls the operation of computer system 1100. One or more processors may be included in processing unit 1104. These processors may include single core or multicore processors. In certain embodiments, processing unit 1104 may be implemented as one or more independent processing units 1132 and/or 1134 with single or multicore processors included in each processing unit. In other embodiments, processing unit 1104 may also be implemented as a quad-core processing unit formed by integrating two dual-core processors into a single chip.

In various embodiments, processing unit 1104 can execute a variety of programs in response to program code and can maintain multiple concurrently executing programs or processes. At any given time, some or all of the program code to be executed can be resident in processor(s) 1104 and/or in storage subsystem 1118. Through suitable programming, processor(s) 1104 can provide various functionalities described above. Computer system 1100 may additionally include a processing acceleration unit 1106, which can include a digital signal processor (DSP), a special-purpose processor, and/or the like.

I/O subsystem 1108 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1100 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 1100 may comprise a storage subsystem 1118 that provides a tangible non-transitory computer-readable storage medium for storing software and data constructs that provide the functionality of the embodiments described in this disclosure. The software can include programs, code modules, instructions, scripts, etc., that when executed by one or more cores or processors of processing unit 1104 provide the functionality described above. Storage subsystem 1118 may also provide a repository for storing data used in accordance with the present disclosure.

As depicted in the example in FIG. 11, storage subsystem 1118 can include various components including a system memory 1110, computer-readable storage media 1122, and a computer readable storage media reader 1120. System memory 1110 may store program instructions that are loadable and executable by processing unit 1104. System memory 1110 may also store data that is used during the execution of the instructions and/or data that is generated during the execution of the program instructions. Various different kinds of programs may be loaded into system memory 1110 including but not limited to client applications, Web browsers, mid-tier applications, relational database management systems (RDBMS), virtual machines, containers, etc.

System memory 1110 may also store an operating system 1116. Examples of operating system 1116 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 1100 executes one or more virtual machines, the virtual machines along with their guest operating systems (GOSs) may be loaded into system memory 1110 and executed by one or more processors or cores of processing unit 1104.

System memory 1110 can come in different configurations depending upon the type of computer system 1100. For example, system memory 1110 may be volatile memory (such as random access memory (RAM)) and/or non-volatile memory (such as read-only memory (ROM), flash memory, etc.) Different types of RAM configurations may be provided including a static random access memory (SRAM), a dynamic random access memory (DRAM), and others. In some implementations, system memory 1110 may include a basic input/output system (BIOS) containing basic routines that help to transfer information between elements within computer system 1100, such as during start-up.

Computer-readable storage media 1122 may represent remote, local, fixed, and/or removable storage devices plus storage media for temporarily and/or more permanently containing, storing, computer-readable information for use by computer system 1100 including instructions executable by processing unit 1104 of computer system 1100.

Computer-readable storage media 1122 can include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 1122 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1122 may include, but is not limited to, Zip® drives, flash memory cards, universal serial bus (USB) flash drives, secure digital (SD) cards, DVD disks, digital video tape, and the like. Computer-readable storage media 1122 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 1100.

Machine-readable instructions executable by one or more processors or cores of processing unit 1104 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 1124 provides an interface to other computer systems and networks. Communications subsystem 1124 serves as an interface for receiving data from and transmitting data to other systems from computer system 1100. For example, communications subsystem 1124 may enable computer system 1100 to connect to one or more devices via the Internet. In some embodiments communications subsystem 1124 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof)), global positioning system (GPS) receiver components, and/or other components. In some embodiments communications subsystem 1124 can provide wired network connectivity (e.g., Ethernet) in addition to or instead of a wireless interface.

In some embodiments, communications subsystem 1124 may also receive input communication in the form of structured and/or unstructured data feeds 1126, event streams 1128, event updates 1130, and the like on behalf of one or more users who may use computer system 1100.

By way of example, communications subsystem 1124 may be configured to receive data feeds 1126 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1124 may also be configured to receive data in the form of continuous data streams, which may include event streams 1128 of real-time events and/or event updates 1130, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1124 may also be configured to output the structured and/or unstructured data feeds 1126, event streams 1128, event updates 1130, and the like to one or more databases that may be in communication with one or more streaming data source computers coupled to computer system 1100.

Computer system 1100 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1100 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

### Example Virtual Networking Architecture

The term cloud service is generally used to refer to a service that is made available by a cloud services provider (CSP) to users or customers on demand (e.g., via a subscription model) using systems and infrastructure (cloud infrastructure) provided by the CSP. Typically, the servers and systems that make up the CSP's infrastructure are separate from the customer's own on-premise servers and systems. Customers can thus avail themselves of cloud services provided by the CSP without having to purchase separate hardware and software resources for the services. Cloud services are designed to provide a subscribing customer easy, scalable access to applications and computing resources without the customer having to invest in procuring the infrastructure that is used for providing the services.

There are several cloud service providers that offer various types of cloud services. There are various different types or models of cloud services including Software-as-a-Service (SaaS), Platform-as-a-Service (PaaS), Infrastructure-as-a-Service (IaaS), and others.

A customer can subscribe to one or more cloud services provided by a CSP. The customer can be any entity such as an individual, an organization, an enterprise, and the like. When a customer subscribes to or registers for a service provided by a CSP, a tenancy or an account is created for that customer. The customer can then, via this account, access the subscribed-to one or more cloud resources associated with the account.

As noted above, infrastructure as a service (IaaS) is one particular type of cloud computing service. In an IaaS model, the CSP provides infrastructure (referred to as cloud services provider infrastructure or CSPI) that can be used by customers to build their own customizable networks and deploy customer resources. The customer's resources and networks are thus hosted in a distributed environment by infrastructure provided by a CSP. This is different from traditional computing, where the customer's resources and networks are hosted by infrastructure provided by the customer.

The CSPI may comprise interconnected high-performance compute resources including various host machines, memory resources, and network resources that form a physical network, which is also referred to as a substrate network or an underlay network. The resources in CSPI may be spread across one or more data centers that may be geographically spread across one or more geographical regions. Virtualization software may be executed by these physical resources to provide a virtualized distributed environment. The virtualization creates an overlay network (also known as a software-based network, a software-defined network, or a virtual network) over the physical network. The CSPI physical network provides the underlying basis for creating one or more overlay or virtual networks on top of the physical network. The physical network (or substrate network or underlay network) comprises physical network devices such as physical switches, routers, computers and host machines, and the like. An overlay network is a logical (or virtual) network that runs on top of a physical substrate network. A given physical network can support one or multiple overlay networks. Overlay networks typically use encapsulation techniques to differentiate between traffic belonging to different overlay networks. A virtual or overlay network is also referred to as a virtual cloud network (VCN). The virtual networks are implemented using software virtualization technologies (e.g., hypervisors, virtualization functions implemented by network virtualization devices (NVDs) (e.g., smartNICs), top-of-rack (TOR) switches, smart TORs that implement one or more functions performed by an NVD, and other mechanisms) to create layers of network abstraction that can be run on top of the physical network. Virtual networks can take on many forms, including peer-to-peer networks, IP networks, and others. Virtual networks are typically either Layer-3 IP networks or Layer-2 VLANs. This method of virtual or overlay networking is often referred to as virtual or overlay Layer-3 networking. Examples of protocols developed for virtual networks include IP-in-IP (or Generic Routing Encapsulation (GRE)), Virtual Extensible LAN (VXLAN—IETF RFC 7348), Virtual Private Networks (VPNs) (e.g., MPLS Layer-3 Virtual Private Networks (RFC 4364)), VMware's NSX, GENEVE (Generic Network Virtualization Encapsulation), and others.

For IaaS, the infrastructure (CSPI) provided by a CSP can be configured to provide virtualized computing resources over a public network (e.g., the Internet). In an IaaS model, a cloud computing services provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (e.g., billing, monitoring, logging, security, load balancing and clustering, etc.). Thus, as these services may be policy-driven, IaaS users may be able to implement policies to drive load balancing to maintain application availability and performance. CSPI provides infrastructure and a set of complementary cloud services that enable customers to build and run a wide range of applications and services in a highly available hosted distributed environment. CSPI offers high-performance compute resources and capabilities and storage capacity in a flexible virtual network that is securely accessible from various networked locations such as from a customer's on-premises network. When a customer subscribes to or registers for an IaaS service provided by a CSP, the tenancy created for that customer is a secure and isolated partition within the CSPI where the customer can create, organize, and administer their cloud resources.

Customers can build their own virtual networks using compute, memory, and networking resources provided by CSPI. One or more customer resources or workloads, such as compute instances, can be deployed on these virtual networks. For example, a customer can use resources provided by CSPI to build one or multiple customizable and private virtual network(s) referred to as virtual cloud networks (VCNs). A customer can deploy one or more customer resources, such as compute instances, on a customer VCN. Compute instances can take the form of virtual machines, bare metal instances, and the like. The CSPI thus provides infrastructure and a set of complementary cloud services that enable customers to build and run a wide range of applications and services in a highly available virtual hosted environment. The customer does not manage or control the underlying physical resources provided by CSPI but has control over operating systems, storage, and deployed applications; and possibly limited control of select networking components (e.g., firewalls).

The CSP may provide a console that enables customers and network administrators to configure, access, and manage resources deployed in the cloud using CSPI resources. In certain embodiments, the console provides a web-based user interface that can be used to access and manage CSPI. In some implementations, the console is a web-based application provided by the CSP.

CSPI may support single-tenancy or multi-tenancy architectures. In a single tenancy architecture, a software (e.g., an application, a database) or a hardware component (e.g., a host machine or a server) serves a single customer or tenant. In a multi-tenancy architecture, a software or a hardware component serves multiple customers or tenants. Thus, in a multi-tenancy architecture, CSPI resources are shared between multiple customers or tenants. In a multi-tenancy situation, precautions are taken and safeguards put in place within CSPI to ensure that each tenant's data is isolated and remains invisible to other tenants.

In a physical network, a network endpoint (“endpoint”) refers to a computing device or system that is connected to a physical network and communicates back and forth with the network to which it is connected. A network endpoint in the physical network may be connected to a Local Area Network (LAN), a Wide Area Network (WAN), or other type of physical network. Examples of traditional endpoints in a physical network include modems, hubs, bridges, switches, routers, and other networking devices, physical computers (or host machines), and the like. Each physical device in the physical network has a fixed network address that can be used to communicate with the device. This fixed network address can be a Layer-2 address (e.g., a MAC address), a fixed Layer-3 address (e.g., an IP address), and the like. In a virtualized environment or in a virtual network, the endpoints can include various virtual endpoints such as virtual machines that are hosted by components of the physical network (e.g., hosted by physical host machines). These endpoints in the virtual network are addressed by overlay addresses such as overlay Layer-2 addresses (e.g., overlay MAC addresses) and overlay Layer-3 addresses (e.g., overlay IP addresses). Network overlays enable flexibility by allowing network managers to move around the overlay addresses associated with network endpoints using software management (e.g., via software implementing a control plane for the virtual network). Accordingly, unlike in a physical network, in a virtual network, an overlay address (e.g., an overlay IP address) can be moved from one endpoint to another using network management software. Since the virtual network is built on top of a physical network, communications between components in the virtual network involves both the virtual network and the underlying physical network. In order to facilitate such communications, the components of CSPI are configured to learn and store mappings that map overlay addresses in the virtual network to actual physical addresses in the substrate network, and vice versa. These mappings are then used to facilitate the communications. Customer traffic is encapsulated to facilitate routing in the virtual network.

Accordingly, physical addresses (e.g., physical IP addresses) are associated with components in physical networks and overlay addresses (e.g., overlay IP addresses) are associated with entities in virtual or overlay networks. A physical IP address is an IP address associated with a physical device (e.g., a network device) in the substrate or physical network. For example, each NVD has an associated physical IP address. An overlay IP address is an overlay address associated with an entity in an overlay network, such as with a compute instance in a customer's virtual cloud network (VCN). Two different customers or tenants, each with their own private VCNs can potentially use the same overlay IP address in their VCNs without any knowledge of each other. Both the physical IP addresses and overlay IP addresses are types of real IP addresses. These are separate from virtual IP addresses. A virtual IP address is typically a single IP address that is represents or maps to multiple real IP addresses. A virtual IP address provides a 1-to-many mapping between the virtual IP address and multiple real IP addresses. For example, a load balancer may use a VIP to map to or represent multiple servers, each server having its own real IP address.

The cloud infrastructure or CSPI is physically hosted in one or more data centers in one or more regions around the world. The CSPI may include components in the physical or substrate network and virtualized components (e.g., virtual networks, compute instances, virtual machines, etc.) that are in an virtual network built on top of the physical network components. In certain embodiments, the CSPI is organized and hosted in realms, regions and availability domains. A region is typically a localized geographic area that contains one or more data centers. Regions are generally independent of each other and can be separated by vast distances, for example, across countries or even continents. For example, a first region may be in Australia, another one in Japan, yet another one in India, and the like. CSPI resources are divided among regions such that each region has its own independent subset of CSPI resources. Each region may provide a set of core infrastructure services and resources, such as, compute resources (e.g., bare metal servers, virtual machine, containers and related infrastructure, etc.); storage resources (e.g., block volume storage, file storage, object storage, archive storage); networking resources (e.g., virtual cloud networks (VCNs), load balancing resources, connections to on-premise networks), database resources; edge networking resources (e.g., DNS); and access management and monitoring resources, and others. Each region generally has multiple paths connecting it to other regions in the realm.

Generally, an application is deployed in a region (i.e., deployed on infrastructure associated with that region) where it is most heavily used, because using nearby resources is faster than using distant resources. Applications can also be deployed in different regions for various reasons, such as redundancy to mitigate the risk of region-wide events such as large weather systems or earthquakes, to meet varying requirements for legal jurisdictions, tax domains, and other business or social criteria, and the like.

The data centers within a region can be further organized and subdivided into availability domains (ADs). An availability domain may correspond to one or more data centers located within a region. A region can be composed of one or more availability domains. In such a distributed environment, CSPI resources are either region-specific, such as a virtual cloud network (VCN), or availability domain-specific, such as a compute instance.

ADs within a region are isolated from each other, fault tolerant, and are configured such that they are very unlikely to fail simultaneously. This is achieved by the ADs not sharing critical infrastructure resources such as networking, physical cables, cable paths, cable entry points, etc., such that a failure at one AD within a region is unlikely to impact the availability of the other ADs within the same region. The ADs within the same region may be connected to each other by a low latency, high bandwidth network, which makes it possible to provide high-availability connectivity to other networks (e.g., the Internet, customers' on-premise networks, etc.) and to build replicated systems in multiple ADs for both high-availability and disaster recovery. Cloud services use multiple ADs to ensure high availability and to protect against resource failure. As the infrastructure provided by the IaaS provider grows, more regions and ADs may be added with additional capacity. Traffic between availability domains is usually encrypted.

In certain embodiments, regions are grouped into realms. A realm is a logical collection of regions. Realms are isolated from each other and do not share any data. Regions in the same realm may communicate with each other, but regions in different realms cannot. A customer's tenancy or account with the CSP exists in a single realm and can be spread across one or more regions that belong to that realm. Typically, when a customer subscribes to an IaaS service, a tenancy or account is created for that customer in the customer-specified region (referred to as the “home” region) within a realm. A customer can extend the customer's tenancy across one or more other regions within the realm. A customer cannot access regions that are not in the realm where the customer's tenancy exists.

An IaaS provider can provide multiple realms, each realm catered to a particular set of customers or users. For example, a commercial realm may be provided for commercial customers. As another example, a realm may be provided for a specific country for customers within that country. As yet another example, a government realm may be provided for a government, and the like. For example, the government realm may be catered for a specific government and may have a heightened level of security than a commercial realm. For example, Oracle Cloud Infrastructure (OCI) currently offers a realm for commercial regions and two realms (e.g., FedRAMP authorized and IL5 authorized) for government cloud regions.

In certain embodiments, an AD can be subdivided into one or more fault domains. A fault domain is a grouping of infrastructure resources within an AD to provide anti-affinity. Fault domains allow for the distribution of compute instances such that the instances are not on the same physical hardware within a single AD. This is known as anti-affinity. A fault domain refers to a set of hardware components (computers, switches, and more) that share a single point of failure. A compute pool is logically divided up into fault domains. Due to this, a hardware failure or compute hardware maintenance event that affects one fault domain does not affect instances in other fault domains. Depending on the embodiment, the number of fault domains for each AD may vary. For instance, in certain embodiments each AD contains three fault domains. A fault domain acts as a logical data center within an AD.

When a customer subscribes to an IaaS service, resources from CSPI are provisioned for the customer and associated with the customer's tenancy. The customer can use these provisioned resources to build private networks and deploy resources on these networks. The customer networks that are hosted in the cloud by the CSPI are referred to as virtual cloud networks (VCNs). A customer can set up one or more virtual cloud networks (VCNs) using CSPI resources allocated for the customer. A VCN is a virtual or software defined private network. The customer resources that are deployed in the customer's VCN can include compute instances (e.g., virtual machines, bare-metal instances) and other resources. These compute instances may represent various customer workloads such as applications, load balancers, databases, and the like. A compute instance deployed on a VCN can communicate with public accessible endpoints (“public endpoints”) over a public network such as the Internet, with other instances in the same VCN or other VCNs (e.g., the customer's other VCNs, or VCNs not belonging to the customer), with the customer's on-premise data centers or networks, and with service endpoints, and other types of endpoints.

The CSP may provide various services using the CSPI. In some instances, customers of CSPI may themselves act like service providers and provide services using CSPI resources. A service provider may expose a service endpoint, which is characterized by identification information (e.g., an IP Address, a DNS name and port). A customer's resource (e.g., a compute instance) can consume a particular service by accessing a service endpoint exposed by the service for that particular service. These service endpoints are generally endpoints that are publicly accessible by users using public IP addresses associated with the endpoints via a public communication network such as the Internet. Network endpoints that are publicly accessible are also sometimes referred to as public endpoints.

In certain embodiments, a service provider may expose a service via an endpoint (sometimes referred to as a service endpoint) for the service. Customers of the service can then use this service endpoint to access the service. In certain implementations, a service endpoint provided for a service can be accessed by multiple customers that intend to consume that service. In other implementations, a dedicated service endpoint may be provided for a customer such that only that customer can access the service using that dedicated service endpoint.

In certain embodiments, when a VCN is created, it is associated with a private overlay Classless Inter-Domain Routing (CIDR) address space, which is a range of private overlay IP addresses that are assigned to the VCN (e.g., 10.0/16). A VCN includes associated subnets, route tables, and gateways. A VCN resides within a single region but can span one or more or all of the region's availability domains. A gateway is a virtual interface that is configured for a VCN and enables communication of traffic to and from the VCN to one or more endpoints outside the VCN. One or more different types of gateways may be configured for a VCN to enable communication to and from different types of endpoints.

A VCN can be subdivided into one or more sub-networks such as one or more subnets. A subnet is thus a unit of configuration or a subdivision that can be created within a VCN. A VCN can have one or multiple subnets. Each subnet within a VCN is associated with a contiguous range of overlay IP addresses (e.g., 10.0.0.0/24 and 10.0.1.0/24) that do not overlap with other subnets in that VCN and which represent an address space subset within the address space of the VCN.

Each compute instance is associated with a virtual network interface card (VNIC), that enables the compute instance to participate in a subnet of a VCN. A VNIC is a logical representation of physical Network Interface Card (NIC). In general. a VNIC is an interface between an entity (e.g., a compute instance, a service) and a virtual network. A VNIC exists in a subnet, has one or more associated IP addresses, and associated security rules or policies. A VNIC is equivalent to a Layer-2 port on a switch. A VNIC is attached to a compute instance and to a subnet within a VCN. A VNIC associated with a compute instance enables the compute instance to be a part of a subnet of a VCN and enables the compute instance to communicate (e.g., send and receive packets) with endpoints that are on the same subnet as the compute instance, with endpoints in different subnets in the VCN, or with endpoints outside the VCN. The VNIC associated with a compute instance thus determines how the compute instance connects with endpoints inside and outside the VCN. A VNIC for a compute instance is created and associated with that compute instance when the compute instance is created and added to a subnet within a VCN. For a subnet comprising a set of compute instances, the subnet contains the VNICs corresponding to the set of compute instances, each VNIC attached to a compute instance within the set of computer instances.

Each compute instance is assigned a private overlay IP address via the VNIC associated with the compute instance. This private overlay IP address is assigned to the VNIC that is associated with the compute instance when the compute instance is created and used for routing traffic to and from the compute instance. All VNICs in a given subnet use the same route table, security lists, and DHCP options. As described above, each subnet within a VCN is associated with a contiguous range of overlay IP addresses (e.g., 10.0.0.0/24 and 10.0.1.0/24) that do not overlap with other subnets in that VCN and which represent an address space subset within the address space of the VCN. For a VNIC on a particular subnet of a VCN, the private overlay IP address that is assigned to the VNIC is an address from the contiguous range of overlay IP addresses allocated for the subnet.

In certain embodiments, a compute instance may optionally be assigned additional overlay IP addresses in addition to the private overlay IP address, such as, for example, one or more public IP addresses if in a public subnet. These multiple addresses are assigned either on the same VNIC or over multiple VNICs that are associated with the compute instance. Each instance however has a primary VNIC that is created during instance launch and is associated with the overlay private IP address assigned to the instance—this primary VNIC cannot be removed. Additional VNICs, referred to as secondary VNICs, can be added to an existing instance in the same availability domain as the primary VNIC. All the VNICs are in the same availability domain as the instance. A secondary VNIC can be in a subnet in the same VCN as the primary VNIC, or in a different subnet that is either in the same VCN or a different one.

A compute instance may optionally be assigned a public IP address if it is in a public subnet. A subnet can be designated as either a public subnet or a private subnet at the time the subnet is created. A private subnet means that the resources (e.g., compute instances) and associated VNICs in the subnet cannot have public overlay IP addresses. A public subnet means that the resources and associated VNICs in the subnet can have public IP addresses. A customer can designate a subnet to exist either in a single availability domain or across multiple availability domains in a region or realm.

As described above, a VCN may be subdivided into one or more subnets. In certain embodiments, a Virtual Router (VR) configured for the VCN (referred to as the VCN VR or just VR) enables communications between the subnets of the VCN. For a subnet within a VCN, the VR represents a logical gateway for that subnet that enables the subnet (i.e., the compute instances on that subnet) to communicate with endpoints on other subnets within the VCN, and with other endpoints outside the VCN. The VCN VR is a logical entity that is configured to route traffic between VNICs in the VCN and virtual gateways (“gateways”) associated with the VCN. Gateways are further described below with respect to FIG. 1. A VCN VR is a Layer-3/IP Layer concept. In one embodiment, there is one VCN VR for a VCN where the VCN VR has potentially an unlimited number of ports addressed by IP addresses, with one port for each subnet of the VCN. In this manner, the VCN VR has a different IP address for each subnet in the VCN that the VCN VR is attached to. The VR is also connected to the various gateways configured for a VCN. In certain embodiments, a particular overlay IP address from the overlay IP address range for a subnet is reserved for a port of the VCN VR for that subnet. For example, consider a VCN having two subnets with associated address ranges 10.0/16 and 10.1/16, respectively. For the first subnet within the VCN with address range 10.0/16, an address from this range is reserved for a port of the VCN VR for that subnet. In some instances, the first IP address from the range may be reserved for the VCN VR. For example, for the subnet with overlay IP address range 10.0/16, IP address 10.0.0.1 may be reserved for a port of the VCN VR for that subnet. For the second subnet within the same VCN with address range 10.1/16, the VCN VR may have a port for that second subnet with IP address 10.1.0.1. The VCN VR has a different IP address for each of the subnets in the VCN.

In some other embodiments, each subnet within a VCN may have its own associated VR that is addressable by the subnet using a reserved or default IP address associated with the VR. The reserved or default IP address may, for example, be the first IP address from the range of IP addresses associated with that subnet. The VNICs in the subnet can communicate (e.g., send and receive packets) with the VR associated with the subnet using this default or reserved IP address. In such an embodiment, the VR is the ingress/egress point for that subnet. The VR associated with a subnet within the VCN can communicate with other VRs associated with other subnets within the VCN. The VRs can also communicate with gateways associated with the VCN. The VR function for a subnet is running on or executed by one or more NVDs executing VNICs functionality for VNICs in the subnet.

Route tables, security rules, and DHCP options may be configured for a VCN. Route tables are virtual route tables for the VCN and include rules to route traffic from subnets within the VCN to destinations outside the VCN by way of gateways or specially configured instances. A VCN's route tables can be customized to control how packets are forwarded/routed to and from the VCN. DHCP options refers to configuration information that is automatically provided to the instances when they boot up.

Security rules configured for a VCN represent overlay firewall rules for the VCN. The security rules can include ingress and egress rules, and specify the types of traffic (e.g., based upon protocol and port) that is allowed in and out of the instances within the VCN. The customer can choose whether a given rule is stateful or stateless. For instance, the customer can allow incoming SSH traffic from anywhere to a set of instances by setting up a stateful ingress rule with source CIDR 0.0.0.0/0, and destination TCP port 22. Security rules can be implemented using network security groups or security lists. A network security group consists of a set of security rules that apply only to the resources in that group. A security list, on the other hand, includes rules that apply to all the resources in any subnet that uses the security list. A VCN may be provided with a default security list with default security rules. DHCP options configured for a VCN provide configuration information that is automatically provided to the instances in the VCN when the instances boot up.

In certain embodiments, the configuration information for a VCN is determined and stored by a VCN Control Plane. The configuration information for a VCN may include, for example, information about: the address range associated with the VCN, subnets within the VCN and associated information, one or more VRs associated with the VCN, compute instances in the VCN and associated VNICs, NVDs executing the various virtualization network functions (e.g., VNICs, VRs, gateways) associated with the VCN, state information for the VCN, and other VCN-related information. In certain embodiments, a VCN Distribution Service publishes the configuration information stored by the VCN Control Plane, or portions thereof, to the NVDs. The distributed information may be used to update information (e.g., forwarding tables, routing tables, etc.) stored and used by the NVDs to forward packets to and from the compute instances in the VCN.

In certain embodiments, the creation of VCNs and subnets are handled by a VCN Control Plane (CP) and the launching of compute instances is handled by a Compute Control Plane. The Compute Control Plane is responsible for allocating the physical resources for the compute instance and then calls the VCN Control Plane to create and attach VNICs to the compute instance. The VCN CP also sends VCN data mappings to the VCN data plane that is configured to perform packet forwarding and routing functions. In certain embodiments, the VCN CP provides a distribution service that is responsible for providing updates to the VCN data plane. Examples of a VCN Control Plane are also depicted in FIGS. 7, 8, 9, and 10 (see references 716, 816, 916, and 1016) and described below.

A customer may create one or more VCNs using resources hosted by CSPI. A compute instance deployed on a customer VCN may communicate with different endpoints. These endpoints can include endpoints that are hosted by CSPI and endpoints outside CSPI.

Various different architectures for implementing cloud-based service using CSPI are depicted in FIGS. 7, 8, 9, 10, 12, 13, 14, 15, and 16, and are described herein. FIG. 12 is a high level diagram of a distributed environment 1200 showing an overlay or customer VCN hosted by CSPI according to certain embodiments. The distributed environment depicted in FIG. 12 includes multiple components in the overlay network. Distributed environment 1200 depicted in FIG. 12 is merely an example and is not intended to unduly limit the scope of claimed embodiments. Many variations, alternatives, and modifications are possible. For example, in some implementations, the distributed environment depicted in FIG. 12 may have more or fewer systems or components than those shown in FIG. 1, may combine two or more systems, or may have a different configuration or arrangement of systems.

As shown in the example depicted in FIG. 12, distributed environment 1200 comprises CSPI 1201 that provides services and resources that customers can subscribe to and use to build their virtual cloud networks (VCNs). In certain embodiments, CSPI 1201 offers IaaS services to subscribing customers. The data centers within CSPI 1201 may be organized into one or more regions. One example region “Region US” 1202 is shown in FIG. 12. A customer has configured a customer VCN 1204 for region 1202. The customer may deploy various compute instances on VCN 1204, where the compute instances may include virtual machines or bare metal instances. Examples of instances include applications, database, load balancers, and the like.

In the embodiment depicted in FIG. 12, customer VCN 1204 comprises two subnets, namely, “Subnet-1” and “Subnet-2”, each subnet with its own CIDR IP address range. In FIG. 12, the overlay IP address range for Subnet-1 is 10.0/16 and the address range for Subnet-2 is 10.1/16. A VCN Virtual Router 1205 represents a logical gateway for the VCN that enables communications between subnets of the VCN 1204, and with other endpoints outside the VCN. VCN VR 1205 is configured to route traffic between VNICs in VCN 1204 and gateways associated with VCN 1204. VCN VR 1205 provides a port for each subnet of VCN 1204. For example, VR 1205 may provide a port with IP address 10.0.0.1 for Subnet-1 and a port with IP address 10.1.0.1 for Subnet-2.

Multiple compute instances may be deployed on each subnet, where the compute instances can be virtual machine instances, and/or bare metal instances. The compute instances in a subnet may be hosted by one or more host machines within CSPI 1201. A compute instance participates in a subnet via a VNIC associated with the compute instance. For example, as shown in FIG. 12, a compute instance C1 is part of Subnet-1 via a VNIC associated with the compute instance. Likewise, compute instance C2 is part of Subnet-1 via a VNIC associated with C2. In a similar manner, multiple compute instances, which may be virtual machine instances or bare metal instances, may be part of Subnet-1. Via its associated VNIC, each compute instance is assigned a private overlay IP address and a MAC address. For example, in FIG. 12, compute instance C1 has an overlay IP address of 10.0.0.2 and a MAC address of M1, while compute instance C2 has an private overlay IP address of 10.0.0.3 and a MAC address of M2. Each compute instance in Subnet-1, including compute instances C1 and C2, has a default route to VCN VR 1205 using IP address 10.0.0.1, which is the IP address for a port of VCN VR 1205 for Subnet-1.

Subnet-2 can have multiple compute instances deployed on it, including virtual machine instances and/or bare metal instances. For example, as shown in FIG. 12, compute instances D1 and D2 are part of Subnet-2 via VNICs associated with the respective compute instances. In the embodiment depicted in FIG. 12, compute instance D1 has an overlay IP address of 10.1.0.2 and a MAC address of MM1, while compute instance D2 has an private overlay IP address of 10.1.0.3 and a MAC address of MM2. Each compute instance in Subnet-2, including compute instances D1 and D2, has a default route to VCN VR 1205 using IP address 10.1.0.1, which is the IP address for a port of VCN VR 1205 for Subnet-2.

VCN A 1204 may also include one or more load balancers. For example, a load balancer may be provided for a subnet and may be configured to load balance traffic across multiple compute instances on the subnet. A load balancer may also be provided to load balance traffic across subnets in the VCN.

A particular compute instance deployed on VCN 1204 can communicate with various different endpoints. These endpoints may include endpoints that are hosted by CSPI 1300 and endpoints outside CSPI 1300. Endpoints that are hosted by CSPI 1201 may include: an endpoint on the same subnet as the particular compute instance (e.g., communications between two compute instances in Subnet-1); an endpoint on a different subnet but within the same VCN (e.g., communication between a compute instance in Subnet-1 and a compute instance in Subnet-2); an endpoint in a different VCN in the same region (e.g., communications between a compute instance in Subnet-1 and an endpoint in a VCN in the same region 1206 or 1210, communications between a compute instance in Subnet-1 and an endpoint in service network 1210 in the same region); or an endpoint in a VCN in a different region (e.g., communications between a compute instance in Subnet-1 and an endpoint in a VCN in a different region 1208). A compute instance in a subnet hosted by CSPI 1201 may also communicate with endpoints that are not hosted by CSPI 1201 (i.e., are outside CSPI 1201). These outside endpoints include endpoints in the customer's on-premise network 1216, endpoints within other remote cloud hosted networks 1218, public endpoints 1214 accessible via a public network such as the Internet, and other endpoints.

Communications between compute instances on the same subnet are facilitated using VNICs associated with the source compute instance and the destination compute instance. For example, compute instance C1 in Subnet-1 may want to send packets to compute instance C2 in Subnet-1. For a packet originating at a source compute instance and whose destination is another compute instance in the same subnet, the packet is first processed by the VNIC associated with the source compute instance. Processing performed by the VNIC associated with the source compute instance can include determining destination information for the packet from the packet headers, identifying any policies (e.g., security lists) configured for the VNIC associated with the source compute instance, determining a next hop for the packet, performing any packet encapsulation/decapsulation functions as needed, and then forwarding/routing the packet to the next hop with the goal of facilitating communication of the packet to its intended destination. When the destination compute instance is in the same subnet as the source compute instance, the VNIC associated with the source compute instance is configured to identify the VNIC associated with the destination compute instance and forward the packet to that VNIC for processing. The VNIC associated with the destination compute instance is then executed and forwards the packet to the destination compute instance.

For a packet to be communicated from a compute instance in a subnet to an endpoint in a different subnet in the same VCN, the communication is facilitated by the VNICs associated with the source and destination compute instances and the VCN VR. For example, if compute instance C1 in Subnet-1 in FIG. 12 wants to send a packet to compute instance D1 in Subnet-2, the packet is first processed by the VNIC associated with compute instance C1. The VNIC associated with compute instance C1 is configured to route the packet to the VCN VR 1205 using default route or port 10.0.0.1 of the VCN VR. VCN VR 1205 is configured to route the packet to Subnet-2 using port 10.1.0.1. The packet is then received and processed by the VNIC associated with D1 and the VNIC forwards the packet to compute instance D1.

For a packet to be communicated from a compute instance in VCN 1204 to an endpoint that is outside VCN 1204, the communication is facilitated by the VNIC associated with the source compute instance, VCN VR 1205, and gateways associated with VCN 1204. One or more types of gateways may be associated with VCN 1204. A gateway is an interface between a VCN and another endpoint, where the another endpoint is outside the VCN. A gateway is a Layer-3/IP layer concept and enables a VCN to communicate with endpoints outside the VCN. A gateway thus facilitates traffic flow between a VCN and other VCNs or networks. Various different types of gateways may be configured for a VCN to facilitate different types of communications with different types of endpoints. Depending upon the gateway, the communications may be over public networks (e.g., the Internet) or over private networks. Various communication protocols may be used for these communications.

For example, compute instance C1 may want to communicate with an endpoint outside VCN 1204. The packet may be first processed by the VNIC associated with source compute instance C1. The VNIC processing determines that the destination for the packet is outside the Subnet-1 of C1. The VNIC associated with C1 may forward the packet to VCN VR 1205 for VCN 1204. VCN VR 1205 then processes the packet and as part of the processing, based upon the destination for the packet, determines a particular gateway associated with VCN 1204 as the next hop for the packet. VCN VR 1205 may then forward the packet to the particular identified gateway. For example, if the destination is an endpoint within the customer's on-premise network, then the packet may be forwarded by VCN VR 1205 to Dynamic Routing Gateway (DRG) gateway 1222 configured for VCN 1204. The packet may then be forwarded from the gateway to a next hop to facilitate communication of the packet to it final intended destination.

Various different types of gateways may be configured for a VCN. Examples of gateways that may be configured for a VCN are depicted in FIG. 12 and described below. Examples of gateways associated with a VCN are also depicted in FIGS. 7, 8, 9, and 10 (for example, gateways referenced by reference numbers 734, 736, 738, 834, 836, 838, 934, 936, 938, 1034, 1036, and 1038) and described below. As shown in the embodiment depicted in FIG. 12, a Dynamic Routing Gateway (DRG) 1222 may be added to or be associated with customer VCN 1204 and provides a path for private network traffic communication between customer VCN 1204 and another endpoint, where the another endpoint can be the customer's on-premise network 1216, a VCN 1208 in a different region of CSPI 1201, or other remote cloud networks 1218 not hosted by CSPI 1201. Customer on-premise network 1216 may be a customer network or a customer data center built using the customer's resources. Access to customer on-premise network 1216 is generally very restricted. For a customer that has both a customer on-premise network 1216 and one or more VCNs 1204 deployed or hosted in the cloud by CSPI 1201, the customer may want their on-premise network 1216 and their cloud-based VCN 1204 to be able to communicate with each other. This enables a customer to build an extended hybrid environment encompassing the customer's VCN 1204 hosted by CSPI 1201 and their on-premises network 1216. DRG 1222 enables this communication. To enable such communications, a communication channel 1224 is set up where one endpoint of the channel is in customer on-premise network 1216 and the other endpoint is in CSPI 1201 and connected to customer VCN 1204. Communication channel 1224 can be over public communication networks such as the Internet or private communication networks. Various different communication protocols may be used such as IPsec VPN technology over a public communication network such as the Internet, Oracle's FastConnect technology that uses a private network instead of a public network, and others. The device or equipment in customer on-premise network 1216 that forms one end point for communication channel 1224 is referred to as the customer premise equipment (CPE), such as CPE 1226 depicted in FIG. 12. On the CSPI 1201 side, the endpoint may be a host machine executing DRG 1222.

In certain embodiments, a Remote Peering Connection (RPC) can be added to a DRG, which allows a customer to peer one VCN with another VCN in a different region. Using such an RPC, customer VCN 1204 can use DRG 1222 to connect with a VCN 1208 in another region. DRG 1222 may also be used to communicate with other remote cloud networks 1218, not hosted by CSPI 1201 such as a Microsoft Azure cloud, Amazon AWS cloud, and others.

As shown in FIG. 12, an Internet Gateway (IGW) 1220 may be configured for customer VCN 1204 the enables a compute instance on VCN 1204 to communicate with public endpoints 1214 accessible over a public network such as the Internet. IGW 1220 is a gateway that connects a VCN to a public network such as the Internet. IGW 1220 enables a public subnet (where the resources in the public subnet have public overlay IP addresses) within a VCN, such as VCN 1204, direct access to public endpoints 1212 on a public network 1214 such as the Internet. Using IGW 1220, connections can be initiated from a subnet within VCN 1204 or from the Internet.

A Network Address Translation (NAT) gateway 1228 can be configured for customer's VCN 1204 and enables cloud resources in the customer's VCN, which do not have dedicated public overlay IP addresses, access to the Internet and it does so without exposing those resources to direct incoming Internet connections (e.g., L4-L7 connections). This enables a private subnet within a VCN, such as private Subnet-1 in VCN 1204, with private access to public endpoints on the Internet. In NAT gateways, connections can be initiated only from the private subnet to the public Internet and not from the Internet to the private subnet.

In certain embodiments, a Service Gateway (SGW) 1226 can be configured for customer VCN 1204 and provides a path for private network traffic between VCN 1204 and supported services endpoints in a service network 1210. In certain embodiments, service network 1210 may be provided by the CSP and may provide various services. An example of such a service network is Oracle's Services Network, which provides various services that can be used by customers. For example, a compute instance (e.g., a database system) in a private subnet of customer VCN 1204 can back up data to a service endpoint (e.g., Object Storage) without needing public IP addresses or access to the Internet. In certain embodiments, a VCN can have only one SGW, and connections can only be initiated from a subnet within the VCN and not from service network 1210. If a VCN is peered with another, resources in the other VCN typically cannot access the SGW. Resources in on-premises networks that are connected to a VCN with FastConnect or VPN Connect can also use the service gateway configured for that VCN.

In certain implementations, SGW 1226 uses the concept of a service Classless Inter-Domain Routing (CIDR) label, which is a string that represents all the regional public IP address ranges for the service or group of services of interest. The customer uses the service CIDR label when they configure the SGW and related route rules to control traffic to the service. The customer can optionally utilize it when configuring security rules without needing to adjust them if the service's public IP addresses change in the future.

A Local Peering Gateway (LPG) 1232 is a gateway that can be added to customer VCN 1204 and enables VCN 1204 to peer with another VCN in the same region. Peering means that the VCNs communicate using private IP addresses, without the traffic traversing a public network such as the Internet or without routing the traffic through the customer's on-premises network 1216. In preferred embodiments, a VCN has a separate LPG for each peering it establishes. Local Peering or VCN Peering is a common practice used to establish network connectivity between different applications or infrastructure management functions.

Service providers, such as providers of services in service network 1210, may provide access to services using different access models. According to a public access model, services may be exposed as public endpoints that are publicly accessible by compute instance in a customer VCN via a public network such as the Internet and or may be privately accessible via SGW 1226. According to a specific private access model, services are made accessible as private IP endpoints in a private subnet in the customer's VCN. This is referred to as a Private Endpoint (PE) access and enables a service provider to expose their service as an instance in the customer's private network. A Private Endpoint resource represents a service within the customer's VCN. Each PE manifests as a VNIC (referred to as a PE-VNIC, with one or more private IPs) in a subnet chosen by the customer in the customer's VCN. A PE thus provides a way to present a service within a private customer VCN subnet using a VNIC. Since the endpoint is exposed as a VNIC, all the features associates with a VNIC such as routing rules, security lists, etc., are now available for the PE VNIC.

A service provider can register their service to enable access through a PE. The provider can associate policies with the service that restricts the service's visibility to the customer tenancies. A provider can register multiple services under a single virtual IP address (VIP), especially for multi-tenant services. There may be multiple such private endpoints (in multiple VCNs) that represent the same service.

Compute instances in the private subnet can then use the PE VNIC's private IP address or the service DNS name to access the service. Compute instances in the customer VCN can access the service by sending traffic to the private IP address of the PE in the customer VCN. A Private Access Gateway (PAGW) 1230 is a gateway resource that can be attached to a service provider VCN (e.g., a VCN in service network 1210) that acts as an ingress/egress point for all traffic from/to customer subnet private endpoints. PAGW 1230 enables a provider to scale the number of PE connections without utilizing its internal IP address resources. A provider needs only configure one PAGW for any number of services registered in a single VCN. Providers can represent a service as a private endpoint in multiple VCNs of one or more customers. From the customer's perspective, the PE VNIC, which, instead of being attached to a customer's instance, appears attached to the service with which the customer wishes to interact. The traffic destined to the private endpoint is routed via PAGW 1230 to the service. These are referred to as customer-to-service private connections (C2S connections).

The PE concept can also be used to extend the private access for the service to customer's on-premises networks and data centers, by allowing the traffic to flow through FastConnect/IPsec links and the private endpoint in the customer VCN. Private access for the service can also be extended to the customer's peered VCNs, by allowing the traffic to flow between LPG 1232 and the PE in the customer's VCN.

A customer can control routing in a VCN at the subnet level, so the customer can specify which subnets in the customer's VCN, such as VCN 1204, use each gateway. A VCN's route tables are used to decide if traffic is allowed out of a VCN through a particular gateway. For example, in a particular instance, a route table for a public subnet within customer VCN 1204 may send non-local traffic through IGW 1220. The route table for a private subnet within the same customer VCN 1204 may send traffic destined for CSP services through SGW 1226. All remaining traffic may be sent via the NAT gateway 1228. Route tables only control traffic going out of a VCN.

Security lists associated with a VCN are used to control traffic that comes into a VCN via a gateway via inbound connections. All resources in a subnet use the same route table and security lists. Security lists may be used to control specific types of traffic allowed in and out of instances in a subnet of a VCN. Security list rules may comprise ingress (inbound) and egress (outbound) rules. For example, an ingress rule may specify an allowed source address range, while an egress rule may specify an allowed destination address range. Security rules may specify a particular protocol (e.g., TCP, ICMP), a particular port (e.g., 22 for SSH, 3389 for Windows RDP), etc. In certain implementations, an instance's operating system may enforce its own firewall rules that are aligned with the security list rules. Rules may be stateful (e.g., a connection is tracked and the response is automatically allowed without an explicit security list rule for the response traffic) or stateless.

Access from a customer VCN (i.e., by a resource or compute instance deployed on VCN 1204) can be categorized as public access, private access, or dedicated access. Public access refers to an access model where a public IP address or a NAT is used to access a public endpoint. Private access enables customer workloads in VCN 1204 with private IP addresses (e.g., resources in a private subnet) to access services without traversing a public network such as the Internet. In certain embodiments, CSPI 1201 enables customer VCN workloads with private IP addresses to access the (public service endpoints of) services using a service gateway. A service gateway thus offers a private access model by establishing a virtual link between the customer's VCN and the service's public endpoint residing outside the customer's private network.

Additionally, CSPI may offer dedicated public access using technologies such as FastConnect public peering where customer on-premises instances can access one or more services in a customer VCN using a FastConnect connection and without traversing a public network such as the Internet. CSPI also may also offer dedicated private access using FastConnect private peering where customer on-premises instances with private IP addresses can access the customer's VCN workloads using a FastConnect connection. FastConnect is a network connectivity alternative to using the public Internet to connect a customer's on-premise network to CSPI and its services. FastConnect provides an easy, elastic, and economical way to create a dedicated and private connection with higher bandwidth options and a more reliable and consistent networking experience when compared to Internet-based connection

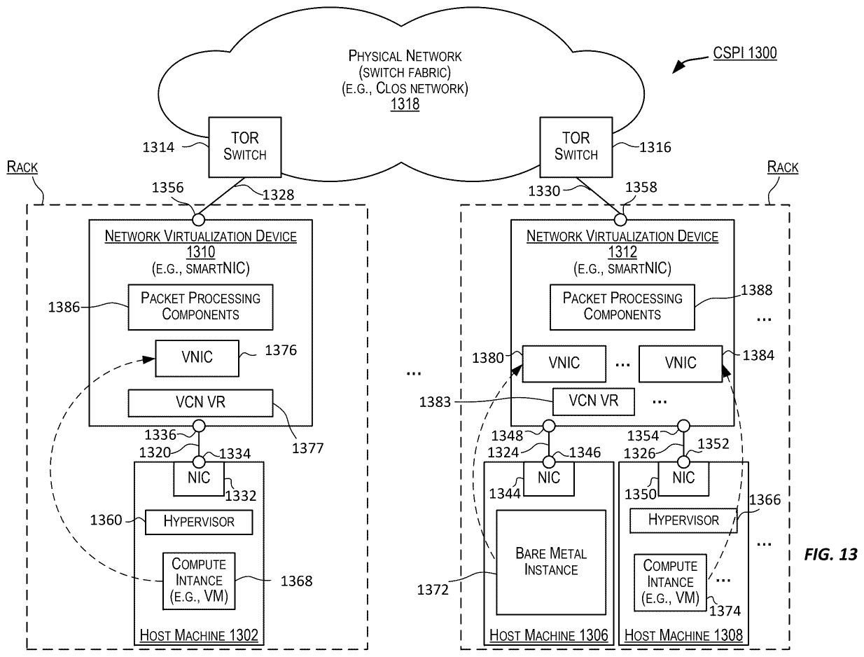

FIG. 12 and the accompanying description above describes various virtualized components in an example virtual network. As described above, the virtual network is built on the underlying physical or substrate network. FIG. 13 depicts a simplified architectural diagram of the physical components in the physical network within CSPI 1300 that provide the underlay for the virtual network according to certain embodiments. As shown, CSPI 1300 provides a distributed environment comprising components and resources (e.g., compute, memory, and networking resources) provided by a cloud service provider (CSP). These components and resources are used to provide cloud services (e.g., IaaS services) to subscribing customers, i.e., customers that have subscribed to one or more services provided by the CSP. Based upon the services subscribed to by a customer, a subset of resources (e.g., compute, memory, and networking resources) of CSPI 1300 are provisioned for the customer. Customers can then build their own cloud-based (i.e., CSPI-hosted) customizable and private virtual networks using physical compute, memory, and networking resources provided by CSPI 1300. As previously indicated, these customer networks are referred to as virtual cloud networks (VCNs). A customer can deploy one or more customer resources, such as compute instances, on these customer VCNs. Compute instances can be in the form of virtual machines, bare metal instances, and the like. CSPI 1300 provides infrastructure and a set of complementary cloud services that enable customers to build and run a wide range of applications and services in a highly available hosted environment.

In the example embodiment depicted in FIG. 13, the physical components of CSPI 1300 include one or more physical host machines or physical servers (e.g., 1302, 1306, 1308), network virtualization devices (NVDs) (e.g., 1310, 1312), top-of-rack (TOR) switches (e.g., 1314, 1316), and a physical network (e.g., 1318), and switches in physical network 1318. The physical host machines or servers may host and execute various compute instances that participate in one or more subnets of a VCN. The compute instances may include virtual machine instances, and bare metal instances. For example, the various compute instances depicted in FIG. 12 may be hosted by the physical host machines depicted in FIG. 13. The virtual machine compute instances in a VCN may be executed by one host machine or by multiple different host machines. The physical host machines may also host virtual host machines, container-based hosts or functions, and the like. The VNICs and VCN VR depicted in FIG. 12 may be executed by the NVDs depicted in FIG. 13. The gateways depicted in FIG. 12 may be executed by the host machines and/or by the NVDs depicted in FIG. 13.

The host machines or servers may execute a hypervisor (also referred to as a virtual machine monitor or VMM) that creates and enables a virtualized environment on the host machines. The virtualization or virtualized environment facilitates cloud-based computing. One or more compute instances may be created, executed, and managed on a host machine by a hypervisor on that host machine. The hypervisor on a host machine enables the physical computing resources of the host machine (e.g., compute, memory, and networking resources) to be shared between the various compute instances executed by the host machine.

For example, as depicted in FIG. 13, host machines 1302 and 1308 execute hypervisors 1360 and 1366, respectively. These hypervisors may be implemented using software, firmware, or hardware, or combinations thereof. Typically, a hypervisor is a process or a software layer that sits on top of the host machine's operating system (OS), which in turn executes on the hardware processors of the host machine. The hypervisor provides a virtualized environment by enabling the physical computing resources (e.g., processing resources such as processors/cores, memory resources, networking resources) of the host machine to be shared among the various virtual machine compute instances executed by the host machine. For example, in FIG. 13, hypervisor 1360 may sit on top of the OS of host machine 1302 and enables the computing resources (e.g., processing, memory, and networking resources) of host machine 1302 to be shared between compute instances (e.g., virtual machines) executed by host machine 1302. A virtual machine can have its own operating system (referred to as a guest operating system), which may be the same as or different from the OS of the host machine. The operating system of a virtual machine executed by a host machine may be the same as or different from the operating system of another virtual machine executed by the same host machine. A hypervisor thus enables multiple operating systems to be executed alongside each other while sharing the same computing resources of the host machine. The host machines depicted in FIG. 13 may have the same or different types of hypervisors.

A compute instance can be a virtual machine instance or a bare metal instance. In FIG. 13, compute instances 1368 on host machine 1302 and 1374 on host machine 1308 are examples of virtual machine instances. Host machine 1306 is an example of a bare metal instance that is provided to a customer.

In certain instances, an entire host machine may be provisioned to a single customer, and all of the one or more compute instances (either virtual machines or bare metal instance) hosted by that host machine belong to that same customer. In other instances, a host machine may be shared between multiple customers (i.e., multiple tenants). In such a multi-tenancy scenario, a host machine may host virtual machine compute instances belonging to different customers. These compute instances may be members of different VCNs of different customers. In certain embodiments, a bare metal compute instance is hosted by a bare metal server without a hypervisor. When a bare metal compute instance is provisioned, a single customer or tenant maintains control of the physical CPU, memory, and network interfaces of the host machine hosting the bare metal instance and the host machine is not shared with other customers or tenants.

As previously described, each compute instance that is part of a VCN is associated with a VNIC that enables the compute instance to become a member of a subnet of the VCN. The VNIC associated with a compute instance facilitates the communication of packets or frames to and from the compute instance. A VNIC is associated with a compute instance when the compute instance is created. In certain embodiments, for a compute instance executed by a host machine, the VNIC associated with that compute instance is executed by an NVD connected to the host machine. For example, in FIG. 13, host machine 1302 executes a virtual machine compute instance 1368 that is associated with VNIC 1376, and VNIC 1376 is executed by NVD 1310 connected to host machine 1302. As another example, bare metal instance 1372 hosted by host machine 1306 is associated with VNIC 1380 that is executed by NVD 1312 connected to host machine 1306. As yet another example, VNIC 1384 is associated with compute instance 1374 executed by host machine 1308, and VNIC 1384 is executed by NVD 1312 connected to host machine 1308.

For compute instances hosted by a host machine, an NVD connected to that host machine also executes VCN VRs corresponding to VCNs of which the compute instances are members. For example, in the embodiment depicted in FIG. 13, NVD 1310 executes VCN VR 1377 corresponding to the VCN of which compute instance 1368 is a member. NVD 1312 may also execute one or more VCN VRs 1383 corresponding to VCNs corresponding to the compute instances hosted by host machines 1306 and 1308.

A host machine may include one or more network interface cards (NIC) that enable the host machine to be connected to other devices. A NIC on a host machine may provide one or more ports (or interfaces) that enable the host machine to be communicatively connected to another device. For example, a host machine may be connected to an NVD using one or more ports (or interfaces) provided on the host machine and on the NVD. A host machine may also be connected to other devices such as another host machine.

For example, in FIG. 13, host machine 1302 is connected to NVD 1310 using link 1320 that extends between a port 1334 provided by a NIC 1332 of host machine 1302 and between a port 1336 of NVD 1310. Host machine 1306 is connected to NVD 1312 using link 1324 that extends between a port 1346 provided by a NIC 1344 of host machine 1306 and between a port 1348 of NVD 1312. Host machine 1308 is connected to NVD 1312 using link 1326 that extends between a port 1352 provided by a NIC 1350 of host machine 1308 and between a port 1354 of NVD 1312.

The NVDs are in turn connected via communication links to top-of-the-rack (TOR) switches, which are connected to physical network 1318 (also referred to as the switch fabric). In certain embodiments, the links between a host machine and an NVD, and between an NVD and a TOR switch are Ethernet links. For example, in FIG. 13, NVDs 1310 and 1312 are connected to TOR switches 1314 and 1316, respectively, using links 1328 and 1330. In certain embodiments, the links 1320, 1324, 1326, 1328, and 1330 are Ethernet links. The collection of host machines and NVDs that are connected to a TOR is sometimes referred to as a rack.

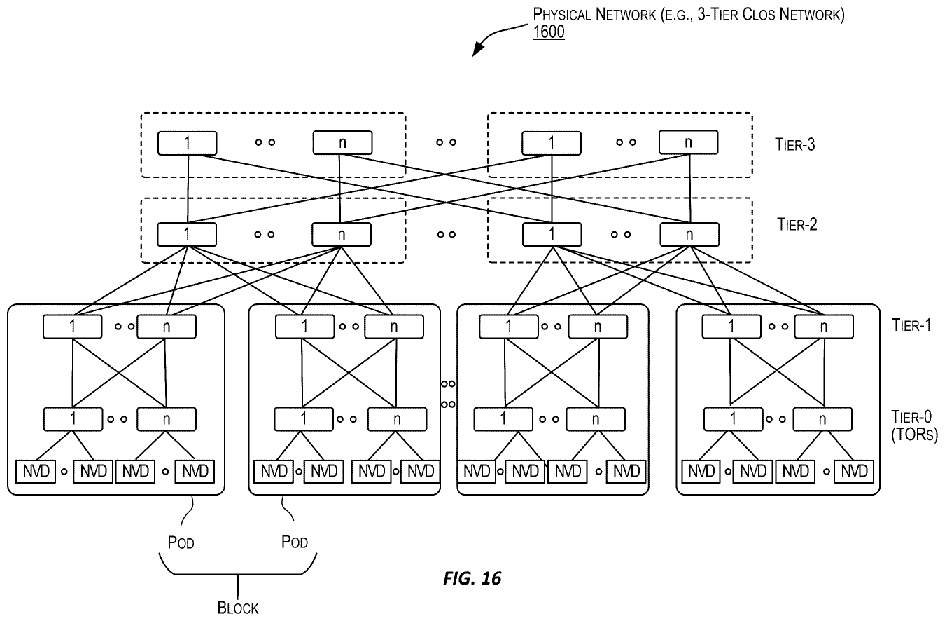

Physical network 1318 provides a communication fabric that enables TOR switches to communicate with each other. Physical network 1318 can be a multi-tiered network. In certain implementations, physical network 1318 is a multi-tiered Clos network of switches, with TOR switches 1314 and 1316 representing the leaf level nodes of the multi-tiered and multi-node physical switching network 1318. Different Clos network configurations are possible including but not limited to a 2-tier network, a 3-tier network, a 4-tier network, a 5-tier network, and in general a “n”-tiered network. An example of a Clos network is depicted in FIG. 16 and described below.

Various different connection configurations are possible between host machines and NVDs such as one-to-one configuration, many-to-one configuration, one-to-many configuration, and others. In a one-to-one configuration implementation, each host machine is connected to its own separate NVD. For example, in FIG. 13, host machine 1302 is connected to NVD 1310 via NIC 1332 of host machine 1302. In a many-to-one configuration, multiple host machines are connected to one NVD. For example, in FIG. 13, host machines 1306 and 1308 are connected to the same NVD 1312 via NICs 1344 and 1350, respectively.

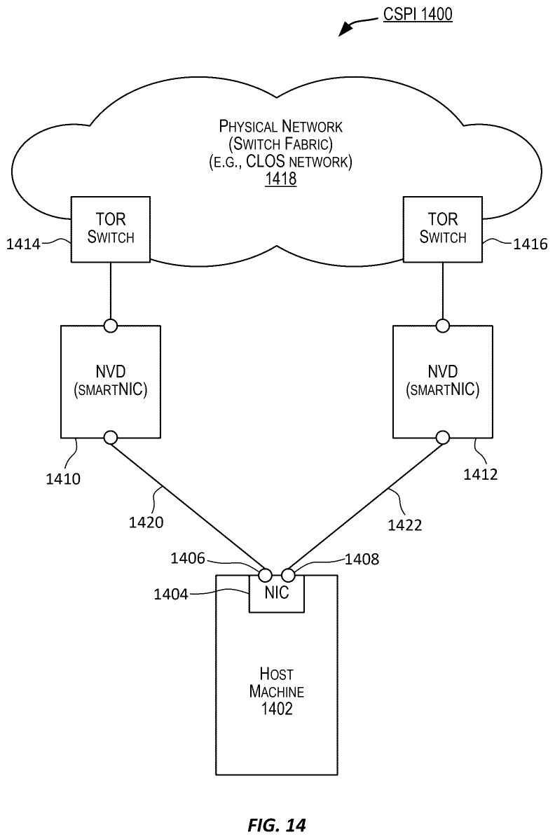

In a one-to-many configuration, one host machine is connected to multiple NVDs. FIG. 14 shows an example within CSPI 1400 where a host machine is connected to multiple NVDs. As shown in FIG. 14, host machine 1402 comprises a network interface card (NIC) 1404 that includes multiple ports 1406 and 1408. Host machine 1400 is connected to a first NVD 1410 via port 1406 and link 1420, and connected to a second NVD 1412 via port 1408 and link 1422. Ports 1406 and 1408 may be Ethernet ports and the links 1420 and 1422 between host machine 1402 and NVDs 1410 and 1412 may be Ethernet links. NVD 1410 is in turn connected to a first TOR switch 1414 and NVD 1412 is connected to a second TOR switch 1416. The links between NVDs 1410 and 1412, and TOR switches 1414 and 1416 may be Ethernet links. TOR switches 1414 and 1416 represent the Tier-0 switching devices in multi-tiered physical network 1418.

The arrangement depicted in FIG. 14 provides two separate physical network paths to and from physical switch network 1418 to host machine 1402: a first path traversing TOR switch 1414 to NVD 1410 to host machine 1402, and a second path traversing TOR switch 1416 to NVD 1412 to host machine 1402. The separate paths provide for enhanced availability (referred to as high availability) of host machine 1402. If there are problems in one of the paths (e.g., a link in one of the paths goes down) or devices (e.g., a particular NVD is not functioning), then the other path may be used for communications to/from host machine 1402.

In the configuration depicted in FIG. 14, the host machine is connected to two different NVDs using two different ports provided by a NIC of the host machine. In other embodiments, a host machine may include multiple NICs that enable connectivity of the host machine to multiple NVDs.

Referring back to FIG. 13, an NVD is a physical device or component that performs one or more network and/or storage virtualization functions. An NVD may be any device with one or more processing units (e.g., CPUs, Network Processing Units (NPUs), FPGAs, packet processing pipelines, etc.), memory including cache, and ports. The various virtualization functions may be performed by software/firmware executed by the one or more processing units of the NVD.

An NVD may be implemented in various different forms. For example, in certain embodiments, an NVD is implemented as an interface card referred to as a smartNIC or an intelligent NIC with an embedded processor onboard. A smartNIC is a separate device from the NICs on the host machines. In FIG. 13, the NVDs 1310 and 1312 may be implemented as smartNICs that are connected to host machines 1302, and host machines 1306 and 1308, respectively.

A smartNIC is however just one example of an NVD implementation. Various other implementations are possible. For example, in some other implementations, an NVD or one or more functions performed by the NVD may be incorporated into or performed by one or more host machines, one or more TOR switches, and other components of CSPI 1300. For example, an NVD may be embodied in a host machine where the functions performed by an NVD are performed by the host machine. As another example, an NVD may be part of a TOR switch or a TOR switch may be configured to perform functions performed by an NVD that enables the TOR switch to perform various complex packet transformations that are used for a public cloud. A TOR that performs the functions of an NVD is sometimes referred to as a smart TOR. In yet other implementations, where virtual machines (VMs) instances, but not bare metal (BM) instances, are offered to customers, functions performed by an NVD may be implemented inside a hypervisor of the host machine. In some other implementations, some of the functions of the NVD may be offloaded to a centralized service running on a fleet of host machines.

In certain embodiments, such as when implemented as a smartNIC as shown in FIG. 13, an NVD may comprise multiple physical ports that enable it to be connected to one or more host machines and to one or more TOR switches. A port on an NVD can be classified as a host-facing port (also referred to as a “south port”) or a network-facing or TOR-facing port (also referred to as a “north port”). A host-facing port of an NVD is a port that is used to connect the NVD to a host machine. Examples of host-facing ports in FIG. 13 include port 1336 on NVD 1310, and ports 1348 and 1354 on NVD 1312. A network-facing port of an NVD is a port that is used to connect the NVD to a TOR switch. Examples of network-facing ports in FIG. 13 include port 1356 on NVD 1310, and port 1358 on NVD 1312. As shown in FIG. 13, NVD 1310 is connected to TOR switch 1314 using link 1328 that extends from port 1356 of NVD 1310 to the TOR switch 1314. Likewise, NVD 1312 is connected to TOR switch 1316 using link 1330 that extends from port 1358 of NVD 1312 to the TOR switch 1316.

An NVD receives packets and frames from a host machine (e.g., packets and frames generated by a compute instance hosted by the host machine) via a host-facing port and, after performing the necessary packet processing, may forward the packets and frames to a TOR switch via a network-facing port of the NVD. An NVD may receive packets and frames from a TOR switch via a network-facing port of the NVD and, after performing the necessary packet processing, may forward the packets and frames to a host machine via a host-facing port of the NVD.

In certain embodiments, there may be multiple ports and associated links between an NVD and a TOR switch. These ports and links may be aggregated to form a link aggregator group of multiple ports or links (referred to as a LAG). Link aggregation allows multiple physical links between two end-points (e.g., between an NVD and a TOR switch) to be treated as a single logical link. All the physical links in a given LAG may operate in full-duplex mode at the same speed. LAGs help increase the bandwidth and reliability of the connection between two endpoints. If one of the physical links in the LAG goes down, traffic is dynamically and transparently reassigned to one of the other physical links in the LAG. The aggregated physical links deliver higher bandwidth than each individual link. The multiple ports associated with a LAG are treated as a single logical port. Traffic can be load-balanced across the multiple physical links of a LAG. One or more LAGs may be configured between two endpoints. The two endpoints may be between an NVD and a TOR switch, between a host machine and an NVD, and the like.

An NVD implements or performs network virtualization functions. These functions are performed by software/firmware executed by the NVD. Examples of network virtualization functions include without limitation: packet encapsulation and de-capsulation functions; functions for creating a VCN network; functions for implementing network policies such as VCN security list (firewall) functionality; functions that facilitate the routing and forwarding of packets to and from compute instances in a VCN; and the like. In certain embodiments, upon receiving a packet, an NVD is configured to execute a packet processing pipeline for processing the packet and determining how the packet is to be forwarded or routed. As part of this packet processing pipeline, the NVD may execute one or more virtual functions associated with the overlay network such as executing VNICs associated with compute instances in the VCN, executing a Virtual Router (VR) associated with the VCN, the encapsulation and decapsulation of packets to facilitate forwarding or routing in the virtual network, execution of certain gateways (e.g., the Local Peering Gateway), the implementation of Security Lists, Network Security Groups, network address translation (NAT) functionality (e.g., the translation of Public IP to Private IP on a host by host basis), throttling functions, and other functions.

In certain embodiments, the packet processing data path in an NVD may comprise multiple packet pipelines, each composed of a series of packet transformation stages. In certain implementations, upon receiving a packet, the packet is parsed and classified to a single pipeline. The packet is then processed in a linear fashion, one stage after another, until the packet is either dropped or sent out over an interface of the NVD. These stages provide basic functional packet processing building blocks (e.g., validating headers, enforcing throttle, inserting new Layer-2 headers, enforcing L4 firewall, VCN encapsulation/decapsulation, etc.) so that new pipelines can be constructed by composing existing stages, and new functionality can be added by creating new stages and inserting them into existing pipelines.

An NVD may perform both control plane and data plane functions corresponding to a control plane and a data plane of a VCN. Examples of a VCN Control Plane are also depicted in FIGS. 7, 8, 9, and 10 (see references 716, 816, 916, and 1016) and described below. Examples of a VCN Data Plane are depicted in FIGS. 7, 8, 9, and 10 (see references 718, 818, 918, and 1018) and described below. The control plane functions include functions used for configuring a network (e.g., setting up routes and route tables, configuring VNICs, etc.) that controls how data is to be forwarded. In certain embodiments, a VCN Control Plane is provided that computes all the overlay-to-substrate mappings centrally and publishes them to the NVDs and to the virtual network edge devices such as various gateways such as the DRG, the SGW, the IGW, etc. Firewall rules may also be published using the same mechanism. In certain embodiments, an NVD only gets the mappings that are relevant for that NVD. The data plane functions include functions for the actual routing/forwarding of a packet based upon configuration set up using control plane. A VCN data plane is implemented by encapsulating the customer's network packets before they traverse the substrate network. The encapsulation/decapsulation functionality is implemented on the NVDs. In certain embodiments, an NVD is configured to intercept all network packets in and out of host machines and perform network virtualization functions.

As indicated above, an NVD executes various virtualization functions including VNICs and VCN VRs. An NVD may execute VNICs associated with the compute instances hosted by one or more host machines connected to the VNIC. For example, as depicted in FIG. 13, NVD 1310 executes the functionality for VNIC 1376 that is associated with compute instance 1368 hosted by host machine 1302 connected to NVD 1310. As another example, NVD 1312 executes VNIC 1380 that is associated with bare metal compute instance 1372 hosted by host machine 1306, and executes VNIC 1384 that is associated with compute instance 1374 hosted by host machine 1308. A host machine may host compute instances belonging to different VCNs, which belong to different customers, and the NVD connected to the host machine may execute the VNICs (i.e., execute VNICs-relate functionality) corresponding to the compute instances.

An NVD also executes VCN Virtual Routers corresponding to the VCNs of the compute instances. For example, in the embodiment depicted in FIG. 13, NVD 1310 executes VCN VR 1377 corresponding to the VCN to which compute instance 1368 belongs. NVD 1312 executes one or more VCN VRs 1383 corresponding to one or more VCNs to which compute instances hosted by host machines 1306 and 1308 belong. In certain embodiments, the VCN VR corresponding to that VCN is executed by all the NVDs connected to host machines that host at least one compute instance belonging to that VCN. If a host machine hosts compute instances belonging to different VCNs, an NVD connected to that host machine may execute VCN VRs corresponding to those different VCNs.

In addition to VNICs and VCN VRs, an NVD may execute various software (e.g., daemons) and include one or more hardware components that facilitate the various network virtualization functions performed by the NVD. For purposes of simplicity, these various components are grouped together as “packet processing components” shown in FIG. 13. For example, NVD 1310 comprises packet processing components 1386 and NVD 1312 comprises packet processing components 1388. For example, the packet processing components for an NVD may include a packet processor that is configured to interact with the NVD's ports and hardware interfaces to monitor all packets received by and communicated using the NVD and store network information. The network information may, for example, include network flow information identifying different network flows handled by the NVD and per flow information (e.g., per flow statistics). In certain embodiments, network flows information may be stored on a per VNIC basis. The packet processor may perform packet-by-packet manipulations as well as implement stateful NAT and L4 firewall (FW). As another example, the packet processing components may include a replication agent that is configured to replicate information stored by the NVD to one or more different replication target stores. As yet another example, the packet processing components may include a logging agent that is configured to perform logging functions for the NVD. The packet processing components may also include software for monitoring the performance and health of the NVD and, also possibly of monitoring the state and health of other components connected to the NVD.

FIG. 12 shows the components of an example virtual or overlay network including a VCN, subnets within the VCN, compute instances deployed on subnets, VNICs associated with the compute instances, a VR for a VCN, and a set of gateways configured for the VCN. The overlay components depicted in FIG. 12 may be executed or hosted by one or more of the physical components depicted in FIG. 13. For example, the compute instances in a VCN may be executed or hosted by one or more host machines depicted in FIG. 13. For a compute instance hosted by a host machine, the VNIC associated with that compute instance is typically executed by an NVD connected to that host machine (i.e., the VNIC functionality is provided by the NVD connected to that host machine). The VCN VR function for a VCN is executed by all the NVDs that are connected to host machines hosting or executing the compute instances that are part of that VCN. The gateways associated with a VCN may be executed by one or more different types of NVDs. For example, certain gateways may be executed by smartNICs, while others may be executed by one or more host machines or other implementations of NVDs.

As described above, a compute instance in a customer VCN may communicate with various different endpoints, where the endpoints can be within the same subnet as the source compute instance, in a different subnet but within the same VCN as the source compute instance, or with an endpoint that is outside the VCN of the source compute instance. These communications are facilitated using VNICs associated with the compute instances, the VCN VRs, and the gateways associated with the VCNs.

For communications between two compute instances on the same subnet in a VCN, the communication is facilitated using VNICs associated with the source and destination compute instances. The source and destination compute instances may be hosted by the same host machine or by different host machines. A packet originating from a source compute instance may be forwarded from a host machine hosting the source compute instance to an NVD connected to that host machine. On the NVD, the packet is processed using a packet processing pipeline, which can include execution of the VNIC associated with the source compute instance. Since the destination endpoint for the packet is within the same subnet, execution of the VNIC associated with the source compute instance results in the packet being forwarded to an NVD executing the VNIC associated with the destination compute instance, which then processes and forwards the packet to the destination compute instance. The VNICs associated with the source and destination compute instances may be executed on the same NVD (e.g., when both the source and destination compute instances are hosted by the same host machine) or on different NVDs (e.g., when the source and destination compute instances are hosted by different host machines connected to different NVDs). The VNICs may use routing/forwarding tables stored by the NVD to determine the next hop for the packet.

For a packet to be communicated from a compute instance in a subnet to an endpoint in a different subnet in the same VCN, the packet originating from the source compute instance is communicated from the host machine hosting the source compute instance to the NVD connected to that host machine. On the NVD, the packet is processed using a packet processing pipeline, which can include execution of one or more VNICs, and the VR associated with the VCN. For example, as part of the packet processing pipeline, the NVD executes or invokes functionality corresponding to the VNIC (also referred to as executes the VNIC) associated with source compute instance. The functionality performed by the VNIC may include looking at the VLAN tag on the packet. Since the packet's destination is outside the subnet, the VCN VR functionality is next invoked and executed by the NVD. The VCN VR then routes the packet to the NVD executing the VNIC associated with the destination compute instance. The VNIC associated with the destination compute instance then processes the packet and forwards the packet to the destination compute instance. The VNICs associated with the source and destination compute instances may be executed on the same NVD (e.g., when both the source and destination compute instances are hosted by the same host machine) or on different NVDs (e.g., when the source and destination compute instances are hosted by different host machines connected to different NVDs).

If the destination for the packet is outside the VCN of the source compute instance, then the packet originating from the source compute instance is communicated from the host machine hosting the source compute instance to the NVD connected to that host machine. The NVD executes the VNIC associated with the source compute instance. Since the destination end point of the packet is outside the VCN, the packet is then processed by the VCN VR for that VCN. The NVD invokes the VCN VR functionality, which may result in the packet being forwarded to an NVD executing the appropriate gateway associated with the VCN. For example, if the destination is an endpoint within the customer's on-premise network, then the packet may be forwarded by the VCN VR to the NVD executing the DRG gateway configured for the VCN. The VCN VR may be executed on the same NVD as the NVD executing the VNIC associated with the source compute instance or by a different NVD. The gateway may be executed by an NVD, which may be a smartNIC, a host machine, or other NVD implementation. The packet is then processed by the gateway and forwarded to a next hop that facilitates communication of the packet to its intended destination endpoint. For example, in the embodiment depicted in FIG. 13, a packet originating from compute instance 1368 may be communicated from host machine 1302 to NVD 1310 over link 1320 (using NIC 1332). On NVD 1310, VNIC 1376 is invoked since it is the VNIC associated with source compute instance 1368. VNIC 1376 is configured to examine the encapsulated information in the packet, and determine a next hop for forwarding the packet with the goal of facilitating communication of the packet to its intended destination endpoint, and then forward the packet to the determined next hop.

A compute instance deployed on a VCN can communicate with various different endpoints. These endpoints may include endpoints that are hosted by CSPI 1300 and endpoints outside CSPI 1300. Endpoints hosted by CSPI 1300 may include instances in the same VCN or other VCNs, which may be the customer's VCNs, or VCNs not belonging to the customer. Communications between endpoints hosted by CSPI 1300 may be performed over physical network 1318. A compute instance may also communicate with endpoints that are not hosted by CSPI 1300, or are outside CSPI 1300. Examples of these endpoints include endpoints within a customer's on-premise network or data center, or public endpoints accessible over a public network such as the Internet. Communications with endpoints outside CSPI 1300 may be performed over public networks (e.g., the Internet) (not shown in FIG. 13) or private networks (not shown in FIG. 13) using various communication protocols.

The architecture of CSPI 1300 depicted in FIG. 13 is merely an example and is not intended to be limiting. Variations, alternatives, and modifications are possible in alternative embodiments. For example, in some implementations, CSPI 1300 may have more or fewer systems or components than those shown in FIG. 13, may combine two or more systems, or may have a different configuration or arrangement of systems. The systems, subsystems, and other components depicted in FIG. 13 may be implemented in software (e.g., code, instructions, program) executed by one or more processing units (e.g., processors, cores) of the respective systems, using hardware, or combinations thereof. The software may be stored on a non-transitory storage medium (e.g., on a memory device).

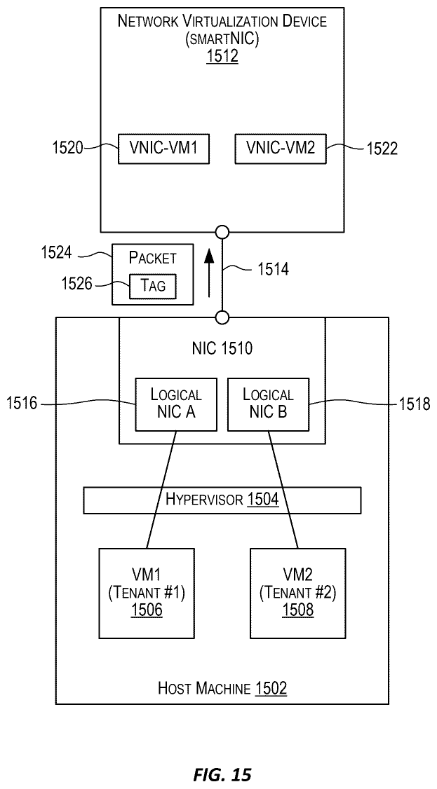

FIG. 15 depicts connectivity between a host machine and an NVD for providing I/O virtualization for supporting multitenancy according to certain embodiments. As depicted in FIG. 15, host machine 1502 executes a hypervisor 1504 that provides a virtualized environment. Host machine 1502 executes two virtual machine instances, VM1 1506 belonging to customer/tenant #1 and VM2 1508 belonging to customer/tenant #2. Host machine 1502 comprises a physical NIC 1510 that is connected to an NVD 1512 via link 1514. Each of the compute instances is attached to a VNIC that is executed by NVD 1512. In the embodiment in FIG. 15, VM1 1506 is attached to VNIC-VM1 1520 and VM2 1508 is attached to VNIC-VM2 1522.

As shown in FIG. 15, NIC 1510 comprises two logical NICs, logical NIC A 1516 and logical NIC B 1518. Each virtual machine is attached to and configured to work with its own logical NIC. For example, VM1 1506 is attached to logical NIC A 1516 and VM2 1508 is attached to logical NIC B 1518. Even though host machine 1502 comprises only one physical NIC 1510 that is shared by the multiple tenants, due to the logical NICs, each tenant's virtual machine believes they have their own host machine and NIC.

In certain embodiments, each logical NIC is assigned its own VLAN ID. Thus, a specific VLAN ID is assigned to logical NIC A 1516 for Tenant #1 and a separate VLAN ID is assigned to logical NIC B 1518 for Tenant #2. When a packet is communicated from VM1 1506, a tag assigned to Tenant #1 is attached to the packet by the hypervisor and the packet is then communicated from host machine 1502 to NVD 1512 over link 1514. In a similar manner, when a packet is communicated from VM2 1508, a tag assigned to Tenant #2 is attached to the packet by the hypervisor and the packet is then communicated from host machine 1502 to NVD 1512 over link 1514. Accordingly, a packet 1524 communicated from host machine 1502 to NVD 1512 has an associated tag 1526 that identifies a specific tenant and associated VM. On the NVD, for a packet 1524 received from host machine 1502, the tag 1526 associated with the packet is used to determine whether the packet is to be processed by VNIC-VM1 1520 or by VNIC-VM2 1522. The packet is then processed by the corresponding VNIC. The configuration depicted in FIG. 15 enables each tenant's compute instance to believe that they own their own host machine and NIC. The setup depicted in FIG. 15 provides for I/O virtualization for supporting multi-tenancy.

FIG. 16 depicts a simplified block diagram of a physical network 1600 according to certain embodiments. The embodiment depicted in FIG. 16 is structured as a Clos network. A Clos network is a particular type of network topology designed to provide connection redundancy while maintaining high bisection bandwidth and maximum resource utilization. A Clos network is a type of non-blocking, multistage or multi-tiered switching network, where the number of stages or tiers can be two, three, four, five, etc. The embodiment depicted in FIG. 16 is a 3-tiered network comprising tiers 1, 2, and 3. The TOR switches 1604 represent Tier-0 switches in the Clos network. One or more NVDs are connected to the TOR switches. Tier-0 switches are also referred to as edge devices of the physical network. The Tier-0 switches are connected to Tier-1 switches, which are also referred to as leaf switches. In the embodiment depicted in FIG. 16, a set of “n” Tier-0 TOR switches are connected to a set of “n” Tier-1 switches and together form a pod. Each Tier-0 switch in a pod is interconnected to all the Tier-1 switches in the pod, but there is no connectivity of switches between pods. In certain implementations, two pods are referred to as a block. Each block is served by or connected to a set of “n” Tier-2 switches (sometimes referred to as spine switches). There can be several blocks in the physical network topology. The Tier-2 switches are in turn connected to “n” Tier-3 switches (sometimes referred to as super-spine switches). Communication of packets over physical network 1600 is typically performed using one or more Layer-3 communication protocols. Typically, all the layers of the physical network, except for the TORs layer are n-ways redundant thus allowing for high availability. Policies may be specified for pods and blocks to control the visibility of switches to each other in the physical network so as to enable scaling of the physical network.

A feature of a Clos network is that the maximum hop count to reach from one Tier-0 switch to another Tier-0 switch (or from an NVD connected to a Tier-0-switch to another NVD connected to a Tier-0 switch) is fixed. For example, in a 3-Tiered Clos network at most seven hops are needed for a packet to reach from one NVD to another NVD, where the source and target NVDs are connected to the leaf tier of the Clos network. Likewise, in a 4-tiered Clos network, at most nine hops are needed for a packet to reach from one NVD to another NVD, where the source and target NVDs are connected to the leaf tier of the Clos network. Thus, a Clos network architecture maintains consistent latency throughout the network, which is important for communication within and between data centers. A Clos topology scales horizontally and is cost effective. The bandwidth/throughput capacity of the network can be easily increased by adding more switches at the various tiers (e.g., more leaf and spine switches) and by increasing the number of links between the switches at adjacent tiers.

In certain embodiments, each resource within CSPI is assigned a unique identifier called a Cloud Identifier (CID). This identifier is included as part of the resource's information and can be used to manage the resource, for example, via a Console or through APIs. An example syntax for a CID is:
ocid1.<RESOURCE TYPE>.<REALM>.[REGION][.FUTURE USE].<UNIQUE ID>
   where,
   ocid1: The literal string indicating the version of the CID;
   resource type: The type of resource (for example, instance, volume, VCN, subnet, user, group, and so on);
   realm: The realm the resource is in. Example values are “c1” for the commercial realm, “c2” for the Government Cloud realm, or “c3” for the Federal Government Cloud realm, etc. Each realm may have its own domain name;
   region: The region the resource is in. If the region is not applicable to the resource, this part might be blank;
   future use: Reserved for future use.
   unique ID: The unique portion of the ID. The format may vary depending on the type of resource or service.

### General Considerations

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or services are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

1. A method comprising:
providing a first private service access (PSA) object for accessing a first cloud service from a virtual cloud network (VCN), the first PSA object being associated with a first VNIC, the first VNIC being associated with a first private internet protocol (IP) address, wherein the first IP address is from a range of private addresses associated with the VCN;
receiving, by the first VNIC associated with the first PSA object, a first request to access the first cloud service from a client connected to the VCN; and
routing the first request to the first cloud service using the first VNIC and the first PSA object.

2. The method of claim 1, wherein the first PSA object is configured to provide access only to the first cloud service.

3. The method of claim 1, further comprising:
providing a second PSA object for accessing a second cloud service from the VCN, wherein the second PSA object is associated with a second private IP address from the range of private addresses associated with the VCN;
receiving a second request to access the second cloud service from the client connected to the VCN; and
routing the second request to the second cloud service using the second PSA object.

4. The method of claim 1, wherein the first VNIC is configured with one or more security attributes to permit or deny network traffic through the first PSA object.

5. The method of claim 4, wherein routing the first request to the first cloud service using the first PSA object comprises:
routing the first request from the first VNIC to a load balancer via cloud service provider infrastructure (CSPI) provided by a cloud service provider (CSP) based on a configuration associated with the first PSA object; and
routing the first request from the load balancer the first cloud service.

6. The method of claim 1, further comprising:
receiving, from the first cloud service and via the first PSA object, a response to the first request.

7. The method of claim 1, further comprising:
receiving a first indication of a selection of the first cloud service from a service catalog provided by a service registry and configuration information for the first PSA object; and
generating the first PSA object.

8. The method of claim 7, wherein generating the first PSA object comprises:
allocating cloud network resources for the first PSA object;
configuring the first PSA object to enable access to the first cloud service using the configuration information for the first PSA object;
generating the first VNIC for the VCN;
associating the first VNIC with the first PSA object to enable communications with the first cloud service; and
associating the private IP address with the first VNIC.

9. The method of claim 8, further comprising:
configuring a DNS record that causes a hostname and a path used to access the first cloud service to resolve to the private IP address.

10. The method of claim 1, wherein the first request to the first cloud service is an application programming interface (“API”) request to an API provided by the first cloud service.

11. The method of claim 1, wherein the range of private addresses associated with the VCN is further associated with a private subnet of the VCN.

12. A non-transitory computer-readable storage medium storing instructions that, when executed by one or more processors, cause the one or more processors to perform operations including:
providing a first PSA object for accessing a first cloud service from a VCN, the first PSA object being associated with a first VNIC, the first VNIC being associated with a first private IP address, wherein the first IP address is from a range of private addresses associated with the VCN;
receiving, by the first VNIC associated with the first PSA object, a first request to access the first cloud service from a client connected to the VCN; and
routing the first request to the first cloud service using the first VNIC and the first PSA object.

13. The non-transitory computer-readable storage medium of claim 12, wherein the first PSA object is configured to provide access only to the first cloud service.

14. The non-transitory computer-readable storage medium of claim 12, wherein the first VNIC is configured with one or more security attributes to permit or deny network traffic through the first PSA object.

15. The non-transitory computer-readable storage medium of claim 12, storing additional instructions that, when executed by the one or more processors, cause the one or more processors to perform operations including:
receive, from the first cloud service and via the first PSA object, a response to the first request.

16. The non-transitory computer-readable storage medium of claim 12, wherein the range of private addresses associated with the VCN is further associated with a private subnet of the VCN.

17. A system comprising:
one or more processors; and
one or more computer-readable storage media storing instructions which, when executed by the one or more processors, cause the one or more processors to perform operations including:
providing a first PSA object for accessing a first cloud service from a VCN, wherein the first PSA object is associated with a first private IP address from a range of private addresses associated with the VCN;
receiving a first request to access the first cloud service from a client connected to the VCN; and
routing the first request to the first cloud service using the first PSA object.

18. The system of claim 17, wherein the first PSA object is configured to provide access only to the first cloud service.

19. The system of claim 17, wherein the first VNIC is configured with one or more security attributes to permit or deny network traffic through the first PSA object.

20. The system of claim 17, wherein the range of private addresses associated with the VCN is further associated with a private subnet of the VCN.
